(19) United States
(12) Patent Application Publication
(10) Pub. No.: US 2013/0304496 A1
(43) Pub. Date: Nov. 14, 2013

(54) SYSTEM AND METHOD FOR OPTIMIZING CLINICAL FLOW AND OPERATIONAL EFFICIENCIES IN A NETWORK ENVIRONMENT

(71) Applicant: Net.Orange, Inc., Dallas, TX (US)

(72) Inventor: Vasu Rangadass, Arlington, TX (US)

(21) Appl. No.: 13/943,706

(22) Filed: Jul. 16, 2013

Related U.S. Application Data
(63) Continuation-in-part of application No. 12/536,060, filed on Aug. 5, 2009.
Application No. 12/536,060 is a continuation-in-part of application No. 12/816,804, filed on Jun. 16, 2010.
Application No. 12/816,804 is a continuation-in-part of application No. 12/536,060, filed on Aug. 5, 2009.
(60) Provisional application No. 61/728,463, filed on Nov. 20, 2012.
(60) Provisional application No. 61/086,344, filed on Aug. 5, 2008.
(60) Provisional application No. 61/086,344, filed on Aug. 5, 2008.

(51) Int. Cl. G06Q 10/06

(52) U.S. Cl. CPC G06Q 10/063114
USPC 705/2

(57) ABSTRACT

A method for optimizing clinical flow and operational efficiencies in a network environment is provided and includes generating a patient care plan for each patient in a medical care facility, generating a patient pathway for each patient, executing the patient care plans and the patient pathways of the respective patients during encounters associated with the respective patients, capturing real time data during the execution of the patient care plans and the patient pathways, performing an analysis on the real time data, and displaying the real time data in a visual display. The patient care plan includes one or more activities, and each activity includes one or more tasks. Each patient pathway includes one or more activities and one or more intermediate products.

### CROSS-REFERENCE TO RELATED APPLICATION

This application claims the benefit of priority under 35 U.S.C. §119(e) to U.S. Provisional Application Ser. No. 61/728,463, entitled “System To Improve Clinical Flow And Optimize Operational Efficiencies In Hospitals” filed Nov. 20, 2012, which is hereby incorporated by reference in its entirety. This application is also a continuation-in-part and claims the benefit of priority under 35 U.S.C. §120 to U.S. application Ser. No. 12/536,060, entitled “Operating System” filed Aug. 5, 2009, which application claims the benefit of priority to U.S. Provisional Application Ser. No. 61/086,344, entitled “Operating System” filed Aug. 5, 2008. This application is also a continuation-in-part and claims the benefit of priority under 35 U.S. §120 to U.S. application Ser. No. 12/816,804, entitled “Operating System” filed Jun. 16, 2010, which application is a continuation-in-part of 12/536,060, entitled “Operating System” filed Aug. 5, 2009, which application in turn claims the benefit of priority to U.S. Provisional Patent Application Ser. No. 61/086,344, entitled “Operating System” filed Aug. 5, 2008. The disclosures of the prior applications are considered part of, and are incorporated by reference in their entireties, in the disclosure of this application.

### TECHNICAL FIELD

This disclosure relates in general to the field of healthcare systems and, more particularly, to a system and a method for optimizing clinical flow and operational efficiencies in a network environment.

### BACKGROUND

Paper-based medical records have been in existence for centuries and are being gradually replaced by computer-based records in modern healthcare systems. Hospitals are increasingly using electronic medical records (EMRs), electronic health records (EHRs), electronic patient records (EPRs), computer-based patient records (CPRS), etc. to capture and manage patients' medical and health information electronically. As of 2002, there were five different types of personal health records: (i) off-line personal health record; (ii) web-based commercial personal health record; (iii) web-based functional personal health record; (iv) provider based personal health record; and (v) web-based partial personal health record. Except for the provider based personal health record, all the other types of personal health records were created by the patient or by third parties, not including the health provider. The types and formats of health records have increased exponentially since 2002, and there currently exists myriad, diverse electronic representations of health and medical records from a wide variety of medical systems and other sources.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram illustrating a healthcare monitoring system for optimizing clinical flow and operational efficiencies in a network environment according to an example embodiment;

FIG. 2 is a simplified block diagram illustrating example details of an embodiment of the healthcare monitoring system;

FIG. 3 is a simplified block diagram illustrating yet other example details of an embodiment of the healthcare monitoring system;

FIG. 4 is a simplified block diagram illustrating yet other example details that may be associated with an embodiment of the healthcare monitoring system;

FIG. 5 is a simplified block diagram illustrating yet other example details that may be associated with an embodiment of the healthcare monitoring system;

FIG. 6 is a simplified block diagram illustrating yet other example details that may be associated with an embodiment of the healthcare monitoring system;

FIG. 7 is a simplified block diagram illustrating yet other example details that may be associated with an embodiment of the healthcare monitoring system;

FIG. 8 is a simplified block diagram illustrating yet other example details that may be associated with an embodiment of the healthcare monitoring system;

FIG. 9 is a simplified block diagram illustrating yet other example details that may be associated with an embodiment of the healthcare monitoring system;

FIG. 10 is a simplified block diagram illustrating yet other example details that may be associated with an embodiment of the healthcare monitoring system;

FIG. 11 is a simplified block diagram illustrating yet other example details that may be associated with an embodiment of the healthcare monitoring system;

FIG. 12 is a simplified diagram illustrating yet other example details that may be associated with an embodiment of the healthcare monitoring system;

FIG. 13 is a simplified diagram illustrating yet other example details that may be associated with an embodiment of the healthcare monitoring system;

FIG. 14 is a simplified diagram illustrating yet other example details that may be associated with an embodiment of the healthcare monitoring system;

FIG. 15 is a simplified diagram illustrating yet other example details that may be associated with an embodiment of the healthcare monitoring system;

FIG. 16 is a simplified diagram illustrating yet other example details that may be associated with an embodiment of the healthcare monitoring system;

FIG. 17 is a simplified flow diagram illustrating example operations that may be associated with an embodiment of the healthcare monitoring system;

FIG. 18 is a simplified flow diagram illustrating yet other example operations that may be associated with an embodiment of the healthcare monitoring system; and

FIG. 19 is a simplified flow diagram illustrating yet other example operations that may be associated with an embodiment of the healthcare monitoring system.

### DETAILED DESCRIPTION OF EXAMPLE EMBODIMENTS

### Overview

A method for optimizing clinical flow and operational efficiencies in a network environment is provided in one example embodiment and includes A method for optimizing clinical flow and operational efficiencies in a network environment is provided and includes generating a patient care plan for each patient in a medical care facility, generating a patient pathway for each patient, executing the patient care plans and the patient pathways of the respective patients during encounters associated with the respective patients, capturing real time data during the execution of the patient care plans and the patient pathways, performing an analysis on the real time data, and displaying the real time data in a visual display. The patient care plan includes one or more activities, and each activity includes one or more tasks. Each patient pathway includes one or more activities and one or more intermediate products.

In example embodiments, each patient is associated with a care plan template, which includes a framework of care for a health population with particular characteristics, condition, diagnosis, and stage in life. In specific embodiments, the real time data includes at least one data selected from a group consisting of medical data, services data, operations data, at least one clinical pathway and at least one services pathway. Each resource may be associated with a cost per unit time and each supply may be associated with a cost per unit item. The analysis can include an analysis of amount of resources, cost of resources, amount of supplies, and cost of supplies associated with the patient during execution of the care plan template.

In some embodiments, each activity may be associated with one or more tasks. Certain tasks may be associated with treatment types categorizing the respective tasks. A sequence of the tasks in a specific order comprises a protocol to be followed for performing the activity during execution of the care plan template. Each task can be categorized as administrative, clinical, or functional type in some embodiments. In other embodiments, each task can be categorized as treatment items or non-treatment items.

### Example Embodiments

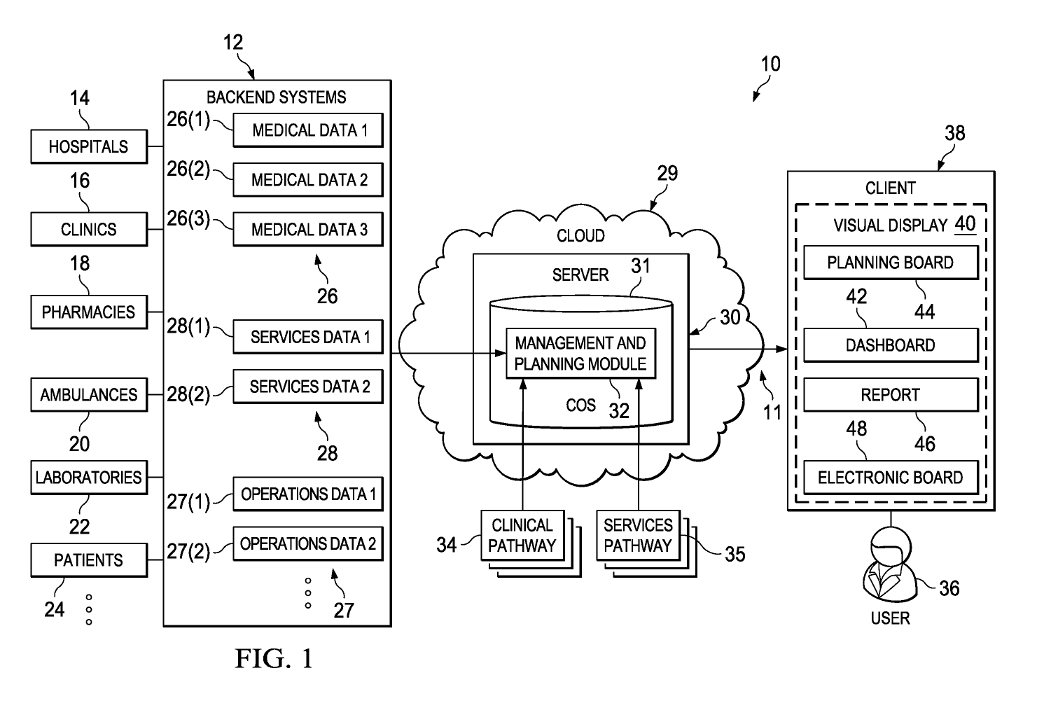

Turning to FIG. 1, FIG. 1 is a simplified block diagram illustrating a healthcare monitoring system 10 for optimizing clinical flow and operational efficiencies in a network environment. Embodiments of healthcare monitoring system 10 may integrate electronic records management, patient flow management, hospital operations management and clinical pathway management into an integrated system for managing operations of a medical care facility. Healthcare monitoring system 10 includes a network 11 (generally indicated by an arrow) comprising backend systems 12 that may be associated with myriad data sources, including hospitals 14, clinics 16, pharmacies 18, ambulances 20, laboratories 22, patients 24, etc. The examples of medical data sources provided herein are merely for ease of illustration, and are not intended to be limitations. Virtually any type and number of medical data sources may be encompassed in the broad scope of the embodiments.

The various medical data sources may generate or provide medical data 26, for example, medical data 26(1)-26(3) comprising various pieces of information in various formats. As used herein, the term “medical data” includes information (e.g., facts) related to diagnosis and treatment of a current or potential health condition (e.g., disease, diabetes, obesity, aging, etc.). Medical data 26 includes health information of an individual (e.g., information pertaining to the health of the individual or health care provided to the individual) collected from the individual at one or more of medical data sources, including hospitals 14, nursing homes, medical centers, clinic 16, health or nursing agencies, health care facilities, or medical data provided by the patients 24, or relatives and friends of the patient.

Medical data 26 can include demographic information (e.g., age, weight, gender) that may be relevant to diagnosis and treatment of a current or potential health condition. Medical data 26 may be generated during encounters (e.g., visit at physician's office, laboratory testing, in-home testing). In a general sense, data, including medical data 26, refers to any type of numeric, text, voice, video, or script data, or any type of source or object code, or any other suitable information in any appropriate format that may be communicated from one point to another in electronic devices and/or networks.

The various medical data sources may also generate or provide operations data 27, for example, operations data 27(1)-27(2). “Operations data” as used herein includes information pertaining to operations of one or more medical care facilities. Operations data 27 can include financial information (e.g., costs of goods and services, salaries of employees, revenue, fees, balance sheet information, profit and loss information), inventory information (e.g., number of beds, equipment, stored medications etc.), management information (e.g., staffing, resource allocation, project and activity timelines, etc.). Virtually any information pertaining to operating a medical care facility can be included in operations data 27.

As used herein, the term “medical care facility” includes an institution, place, building (or parts thereof), entity, organization, or agency, that furnishes, conducts, and operates health services for the prevention, diagnosis, or treatment of mental and/or physical human disease, pain, injury, deformity, or condition. Examples of medical care facilities include hospitals, sanitariums, nursing homes, intermediate care facilities, extended care facilities, mental hospitals, psychiatric hospitals and intermediate care facilities established primarily for the medical, psychiatric or psychological treatment and rehabilitation of individuals with substance abuse, specialized centers or clinics or that portion of a physician's office developed for the provision of outpatient or ambulatory surgery, cardiac catheterization, computed tomography (CT) scanning, stereotactic radio surgery, lithotripsy, magnetic resonance imaging (MRI), magnetic source imaging (MSI), positron emission tomography (PET) scanning, radiation therapy, stereotactic radiotherapy, proton beam therapy, nuclear medicine imaging, or such other specialty services as may be designated by appropriate regulation, and rehabilitation hospitals.

The various medical data sources may also generate or provide services data 28, for example, services data 28(1)-28(2). “Services data” as used herein includes information pertaining to health care services. Health care services that generate services data 28 can include diagnostic (e.g., diagnosis of health conditions and diseases), therapeutic (e.g., treatment of health condition and diseases), custodial (e.g., care provided by a nursing home or hospital) care services and any other type of services for the prevention, diagnosis, or treatment of mental and/or physical human disease, pain, injury, deformity, or condition. Services data can include data pertaining to primary health care services (e.g., care and services provided by a physician and nurse under the direct guidance of a physician) and ancillary services (e.g., supplies and laboratory tests provided under home care, audiology, durable medical equipment (DME), ambulatory surgical centers (ASC), home infusion, hospice care, skilled nursing facility (SNF), cardiac testing, mobile lithotripsy, fitness center, radiology, pulmonary testing, sleep centers, and kidney dialysis).

Backend systems 12 may communicate medical data 26, operations data 27 and services data 28 to a cloud 29 comprising a server 30 provisioned with a clinical operating system (cOS) 31, which includes a management and planning module 32. One or more clinical pathway 34 may be provided to management and planning module 32. “Clinical pathway” as used herein includes a treatment care plan, comprising one or more treatment measures (e.g., includes clinical and other related measures (e.g., events, activities, procedures, actions) provided to (or performed on) a patient) specified to be delivered to a patient according to a predetermined schedule. For example, treatment measures for an ante partum clinical pathway can include: review of history for factors that can affect pregnancy outcome; review of medication and allergy; review of past complications that could repeat in future pregnancies; review of lifestyle issues that can affect pregnancy outcome; pelvic examination; pap smear, etc. Treatment measures for a diabetic inpatient foot care clinical pathway can include inspecting feet within 4 hours of admission; determining if skin discoloration exists; diagnosing whether ulcer, foot sepsis, etc., exists; recommending surgical review; etc.

In some embodiments, each individual patient may be associated with a unique clinical pathway 34, identified by the patient's identifier (e.g., social security number, first and last name, or other suitable identifier). Clinical pathway 34 can include a statement of the individual's assessed health care services needs setting out what services s/he should get, why, when, and details of who can provide it (or is responsible for providing it). Clinical pathway 34 can include nursing orders (e.g., setting out guidance to nursing care) for a specific patient, general (e.g., standardized) treatment plans for a specific disease individualized to the specific patient, and other health care treatment related to the specific patient. In other embodiments, a generic clinical pathway 34 may be associated with substantially all patients (in the hospital or health care setting) having the health condition relevant to the clinical pathway. Clinical pathway 34 can specify a recommended care process, sequencing and timing of interventions by healthcare professionals for a particular diagnosis or procedure.

One or more services pathway 35 may be provided to management and planning module 32. “Services pathway” as used herein includes a break down of a service line (e.g., cardiac surgery) into intermediate products (e.g., admissions, physical examinations, meals, laboratory tests, radiology procedures, surgeries, physical therapy, etc.) and their inter-relationships as applied to a specific medical care facility. A service line is a group of services that are related to each other by various factors, such as the type of clinical need they satisfy or a category of diagnosis. Often, the service line may be defined based on a specific patient population's primary diagnosis, such as heart disease. The service line may include homogeneous groups of patients around which resources can be focused and coordinated. For example, service lines may be classified according to fields, such as Cardiology; Orthopedics; Radiology; Women's Health; Oncology; etc. In an example embodiment, service pathway 35 may include a list of intermediate products, ordered according to the time sequence of delivery to the patients. Each service line may be associated with one or more service pathways 35. Services pathway 35 can include a list of non-clinical items associated with the medical care facility, such as resources and supplies used for the service, costs associated with the service, etc.

According to various embodiments, management and planning module 32 may enable a user 36 to view clinical flows and operational efficiencies associated with one or more medical care facilities at client 38 on a suitable visual display 40 based on medical data 26, operations data 27, services data 28, clinical pathway 34, and services pathway 35. Clinical flows and operational efficiencies associated with one or more medical care facilities may be viewed through one or more charts, tables, diagrams, and other data visualization tools, such as a dashboard 42, a planning board 44, a report 46 and an electronic board 48.

As used herein, the term “dashboard” includes a data visualization tool that can be used to display a plurality of performance indicators and other relevant information pertaining to the one or more medical care facilities. Dashboard 42 may be displayed in real-time after retrieval from one or more data sources in cloud 29. Dashboard 42 can be interactive, allowing drill down (e.g., move from summary information to detailed data, for example, by clicking on the summary information) into particular aspects of the tool or switch between facets or views of the presented information. Dashboard 42 can be presented as a chart, table, grid, gauge, map, or other suitable data visualization tool.

As used herein, the term “planning board” includes a data visualization tool that can be used to display one or more operational metrics for planning operations of the one or more medical care facilities. Planning board 44 may differ from dashboard 42 in the content of the display in some embodiments. For example, planning board 44 may display real time operational metrics relevant to a ward manager in the medical care facility, whereas dashboard 42 may display real time operational metrics relevant to an executive officer of the medical care facility. In other embodiments, planning board 44 may differ from dashboard 42 in the format of the display. For example, planning board 44 may display data in a table form, whereas dashboard 42 may display data in a graphical form. In yet other embodiments, planning board 44 may be substantially identical to dashboard 42, yet may be called different names within the medical care facility (for example, for ease of administrative use).

As used herein, a “report” is a data visualization tool that can be used to display details associated with dashboard 42, and/or planning board 44. Report 46 may differ from dashboard 42, and/or planning board 44 by virtue of static fields that are not amenable to further drill down. For example, report 46 may present substantially all details (included in healthcare monitoring system 10) of a particular data (e.g., patient X's payment information) compared to planning board 44 or dashboard 42. As used herein, the term “electronic board” includes a data visualization tool that can be used to display one or more clinical management plans associated with a specific patient at the one or more medical care facilities. Electronic board 48 may differ from dashboard 42 in the content of the display in some embodiments.

For purposes of illustrating the techniques of healthcare monitoring system 10, it is important to understand the communications in a given system such as the system shown in FIG. 1. The following foundational information may be viewed as a basis from which the present disclosure may be properly explained. Such information is offered earnestly for purposes of explanation only and, accordingly, should not be construed in any way to limit the broad scope of the present disclosure and its potential applications.

The development of an Information Technology (IT) infrastructure in healthcare delivery has enormous potential to improve the safety, quality, and efficiency of health care and health delivery. Computer-assisted diagnosis can improve clinical decision making. Computer-based reminder systems can improve compliance with preventive service protocols. Immediate access to computer-based clinical information, such as laboratory and radiology results can improve quality of healthcare delivery. Likewise, the availability of complete patient health information at the point of care delivery, clinical decision support systems and other computer-assisted healthcare monitoring systems can prevent many errors and adverse events. Patient health information can be shared among all authorized participants in the health care community via secure IT infrastructure

In healthcare settings, the absence of a formal care planning system can leads to errors of omission. Consequently, crucial steps in the care process can be forgotten or not followed through appropriately. Further, a team approach is often lacking, resulting in poor discharge planning and inadequate patient education. Clinical pathways to alleviate such problems are typically developed through collaborative efforts of clinicians, case managers, nurses, and other healthcare professionals. Clinical pathways can reduce unnecessary variation in patient care, reduce delays, and improve the cost-effectiveness of medical services. Clinical pathways may be considered a form of multidisciplinary management plans that display goals for patients and provide the corresponding appropriate sequence and timing of staff interventions to achieve those goals with optimal efficiency.

One of the typical goals of implementing clinical pathways includes examining the interrelationships among the different steps and stages in the care process and to engineer strategies to coordinate or decrease the time spent in the rate limiting steps. It can also aim to provide a framework for collecting and analyzing data on the care process so that providers can understand how often and why patients do not follow an expected course during their hospitalization. In some cases, the clinical pathway can be a plan of care that reflects best clinical practice and the expressed needs of a typical patient on the pathway. Such a clinical pathway represents the minimum standard of care and ensures that the essentials are not forgotten and are performed on time. Clinical pathways are typically written in the form of a grid (or matrix) which displays aspects of care on one axis and time intervals on another. The time intervals are typically in the form of a day by day clinical order and documentation sheet with variations depending on the nature and progression of illness or procedure being performed. For example, clinical pathways designed for chronic conditions could have timelines in the form of weeks or months.

Clinical pathways are often used to collect and analyze information for determining when patients deviate from the clinical pathway. Analysis of variation from clinical pathways can provide useful and accurate information on the frequency and causes of variations in patient care. For example, the analysis can encourage members of the healthcare team to adhere to the guidelines (specified in the clinical pathway) more strictly in the future. Thus, clinical pathways can compel healthcare providers to critically evaluate and understand the basis of clinical decisions.

Analysis of variance can be a powerful clinical audit tool to review and revise aspects of patient care at a hospital or other healthcare facility. The recording, collection and analysis of variances provide continuous audit data on the care being delivered. Such audit information may be specific to each case on the clinical pathway being analyzed. Analysis can highlight deficiencies in the care process due to problems arising from the hospital system. Clinical pathways can also facilitate outcome audit analysis as relevant documents can be identified and studied to ascertain whether or not the interventions resulted in the desired clinical outcomes as stated on the clinical pathway.

Computers clinical pathways analysis may be performed inside a larger Clinical Decision Support System (CDSS). CDSSs are typically designed to integrate a medical knowledge base, patient data and an inference engine to generate case specific advice. Characteristics of individual patients may be used to generate patient-specific assessments or recommendations that are then presented to clinicians for consideration. Four functions of electronic clinical decision support systems include: Administrative functions (e.g., supporting clinical coding and documentation, authorization of procedures, and referrals); management functions (e.g., keeping patients on research and chemotherapy protocols, tracking orders, referrals follow-up, and preventive care); cost control functions (e.g., monitoring medication orders, avoiding duplicate or unnecessary tests); and decision support functions (e.g., supporting clinical diagnosis and treatment plan processes, and promoting use of best practices, condition-specific guidelines, and population-based management).

Examples of CDSSs include manual or computer based systems that attach care reminders to the charts of patients needing specific preventive care services and computerized physician order entry systems that provide patient-specific recommendations as part of the order entry process. Such systems generally improve prescribing practices, reduce serious medication errors, enhance the delivery of preventive care services, and improve adherence to recommended care standards, for example, as specified in appropriate clinical pathways.

CDSSs typically include dashboards and other data visualization tools to enable a decision maker to see data and associated analysis, and reach a conclusion in a time efficient manner. However, CDSSs can often be stand-alone applications poorly integrated into the clinician's or a hospital's workflow. Moreover, decision support interventions may not be tightly coupled to actions (e.g., the ability to immediately order the medication triggered by a reminder). Further, CDSS may not be associated with a medical care facility's operations, and may be a separate application that cannot be accessed via the medical care facility's operations application, if any. Some hospitals use flow charts and production statistics to help improve their workflows, but there is a lack of real-time data that can prevent addressing high priority workflow decisions in a combined clinical-and-business setting.

Poorly managed patient flow can be evidenced through overcrowding and boarding in emergency department or post-anesthesia care units; delayed or postponed surgeries on the operating room schedule; delays in providing care to patients; overburdened staff and physicians; overburdened or under-utilized laboratories and other facilities/equipment; etc. Moreover, although some CDSS and other systems may facilitate patient flow tracking, there is a lack of direct association with business metrics, such as revenue and costs associated with providing of medical services, particularly in real time.

As hospitals vie for market superiority, they may decide which services to grow and how to grow them. With increasing competition and limited capital, most hospitals cannot sustain market excellence in every clinical program. Faced with these challenges, hospitals may consider service-line management. Service-line management is often seen as a way to provide a more coordinated, higher quality clinical service. However, it can also represent a better way to conduct the business of healthcare delivery particularly as it pertains to strategic focus. For example, cardiovascular service lines typically focus on length of stay of congestive heart failure patients and acute myocardial infarction patients. The length of stay is a measurable data tracked in reports that summarize further analysis on the data. A number of technology solutions are evolving to address the service line management model, including the dashboard concept. Dashboards within a service line can provide a snapshot of volumes, revenues, or costs to facilitate monitoring and managing the entire continuum of the care in a specific DRG.

Healthcare monitoring system 10 is configured to address these issues (and others) in offering a system and a method for optimizing clinical flow and operational efficiencies in a network environment. Embodiments of healthcare monitoring system 10 can provide a suitable visual display 40 that can enable user 36 to view clinical flows and operational efficiencies associated with one or more medical care facilities. In various embodiments, client 38 may request for medical data 26, operations data 27, services data 28, clinical pathway 34 and services pathway 35 from cloud 29, for example, through a secure HTTP request via a browser when user 36 clicks on (or otherwise selects) an option for displaying visual display 40 comprising one of planning board 44, dashboard 42, report 46 or electronic board 48. Management and planning module 32 may respond with data rendering instructions to client 38. The data rendering instructions may allow client 38 to access medical data 26, operations data 27, services data 28, clinical pathway 34, and services pathway 35 and display them suitably.

According to many embodiments, visual display 40 may provide a summarized view of real time data captured during execution of a patient care plan, and can include a drill-down option to review details of the real time data. For example, the real time data may indicate an actual length of stay of a patient at a medical care facility, with a link to drill down into details of treatment measures provided to the patient during the actual length of stay. The drill-down may reveal problems or issues relevant to the operations of the medical care facility, for example, indicating a shortage of nurses at a specific time during each day, potentially causing the actual length of stay to exceed the expected length of stay. In some embodiments, visual display 40 may correspond to a role of user 36 who has logged into healthcare monitoring system 10 on client 38. For example, visual display 40 seen by a Chief Medical Officer of a medical care facility may be different from visual display 40 seen by a Chief Financial Officer of the same medical care facility.

In many embodiments, online analytical process (OLAP) may be embedded in healthcare monitoring system 10 to facilitate the operations described herein. Some embodiments may implement asynchronous JavaScript XML-HTTP-Request (AJAX) model to retrieve instant information and avoid lag in transportation of client-server data. For example, transient data may be stored at client 38, thereby reducing redundant data query with server 30 in cloud 29. Heavyweight database queries may be implemented at server 30, and lightweight data analysis may be performed at client 38. With AJAX, browsers at client 38 can send data to, and retrieve data from, server 30 asynchronously (e.g., in the background) without interfering with visual display 40. For example, data can be retrieved using an XMLHttpRequest object.

Medical data 26 provided by backend systems 12 may be appropriately tagged or otherwise identified as belonging to, or being associated with, a particular clinical pathway 34 and/or treatment measure provided to a specific patient. According to embodiments of healthcare monitoring system 10, dashboard 42 can display a quantitative analysis of clinical flows and operational efficiency with immediacy and intuitiveness. Dashboard 42 may communicate relevant information quickly and compellingly, with clarity, and simplicity. Dashboard 42 may organize business information (such as information relevant to clinical flows and operational efficiency) to support meaning and usability. Dashboard 42 may display strategic information, for example, sufficient to obtain a quick overview of the medical care facility's overall operational health, or patients' healthcare experience at the medical care facility, in general. Dashboard 42 may display analytic information, for example, sufficient to obtain an understanding of a specific performance metric, for example revenue targets. Dashboard 42 may display operational information, for example, facilitating constant, real-time monitoring to provide an in-depth understanding of the day-to-day operations of the medical care facility, or a specific patient's ongoing healthcare experience.

Dashboard 42 may be configured for display based on user 36's roles and/or access privileges to access healthcare monitoring system 10. For example, a medical officer may view certain information (e.g., patient care provided, patient response to treatment) on dashboard 42 based on a subset of medical data 26, operations data 27, services data 28, clinical pathway 34 (e.g., related to a specific patient, or a specific group of patients) and services pathway (e.g., related to a specific medical care facility); a financial officer may view certain other information (e.g., revenue generated, cost of providing service) on dashboard 42 based on the same subset of medical data 26, operations data 27, services data 28, clinical pathway 34, and services pathway 35; an executive officer may view yet other information (e.g., operational efficiencies, bottlenecks in service line management) on dashboard 42 based on the same subset of medical data 26, operations data 27, services data 28, clinical pathway 34, and services pathway 35.

Turning to the infrastructure of healthcare monitoring system 10, the network topology of network 11 can include any number of servers, routers, gateways, and other nodes inter-connected to form a large and complex network. A node may be any electronic device, client, server, peer, service, application, or other object capable of sending, receiving, or forwarding information over communications channels in a network. Elements of FIG. 1 may be coupled to one another through one or more interfaces employing any suitable connection (wired or wireless), which provides a viable pathway for electronic communications. Additionally, any one or more of these elements may be combined or removed from the architecture based on particular configuration needs.

Healthcare monitoring system 10 may include a configuration capable of TCP/IP communications for the electronic transmission or reception of data packets in a network. Healthcare monitoring system 10 may also operate in conjunction with a User Datagram Protocol/Internet Protocol (UDP/IP) or any other suitable protocol, where appropriate and based on particular needs. In addition, gateways, routers, switches, and any other suitable nodes (physical or virtual) may be used to facilitate electronic communication between various nodes in the network.

Note that the numerical and letter designations assigned to the elements of FIG. 1 do not connote any type of hierarchy; the designations are arbitrary and have been used for purposes of teaching only. Such designations should not be construed in any way to limit their capabilities, functionalities, or applications in the potential environments that may benefit from the features of healthcare monitoring system 10. It should be understood that the healthcare monitoring system 10 shown in FIG. 1 is simplified for ease of illustration.

The example network environment may be configured over a physical infrastructure that may include one or more networks and, further, may be configured in any form including, but not limited to, local area networks (LANs), wireless local area networks (WLANs), virtual local area networks (VLANs), metropolitan area networks (MANs), wide area networks (WANs), virtual private networks (VPNs), Intranet, Extranet, any other appropriate architecture or system, or any combination thereof that facilitates communications in a network.

In some embodiments, a communication link may represent any electronic link supporting a LAN environment such as, for example, cable, Ethernet, wireless technologies (e.g., IEEE 802.11x), ATM, fiber optics, etc. or any suitable combination thereof. In other embodiments, communication links may represent a remote connection through any appropriate medium (e.g., digital subscriber lines (DSL), telephone lines, T1 lines, T3 lines, wireless, satellite, fiber optics, cable, Ethernet, etc. or any combination thereof) and/or through any additional networks such as a wide area networks (e.g., the Internet).

In various embodiments, cOS 31 may include a suitable operating system (or platform, or other appropriate software) that can federate medical data 26, operations data 27, services data 28, clinical pathway 34, and services pathway 35 into a federated centralized database, aggregate medical data 26, operations data 27, services data 28, clinical pathway 34, and services pathway 35, convert medical data 26, operations data 27, services data 28, clinical pathway 34, and services pathway 35 from disparate formats to a uniform format (e.g., XML based format), and store medical data 26, operations data 27, services data 28, clinical pathway 34, and services pathway 35 in a suitable data store (e.g., federated centralized database; data store for aggregated data) in cloud 29. cOS 31 may comprise a plurality of self-contained interconnected modules and service layers for connecting proprietary (and public) systems together and extracting and translating data therefrom to enable them to cooperate in a software ecosystem while allowing flexible connections with both existing and new applications.

According to various embodiments, server 30 includes a software program, or a computing device on which the program runs, that provides a specific kind of service to client software (e.g., client 38) running on the same computing device or other computing devices on network 11. Client 38 may include any electronic device, client, server, peer, service, application, or other object capable of sending, receiving, or forwarding information over a network (e.g., network 11). Examples of client 38 include computers, laptops, smart phones, printers, etc. Client 38 may be provisioned with suitable interfaces (e.g., web browsers) that can suitably render medical data 26, operations data 27, services data 28, clinical pathway 34, and services pathway 35, including browser code. In a general sense, client 38 may provide a user interface, such as a graphical user interface (GUI), and perform some or all of the processing on requests it makes from server 30, which maintains the data (e.g., medical data 26, operations data 27, services data 28, clinical pathway 34, and services pathway 35) and processes the requests. For ease of illustration, only one server 30 and one client 38 are illustrated in the FIGURE. Virtually any number of servers and clients may be included in healthcare monitoring system 10 within the broad scope of the embodiments.

In some embodiments, management and planning module 32 may be an application installed on, and executing in, server 30 located in a network (e.g., cloud 29) remote from backend systems 12 and client 38. As used herein, the term “application” can be inclusive of an executable file comprising instructions that can be understood and processed on a computer, and may further include library modules loaded during execution, object files, system files, hardware logic, software logic, or any other executable modules. In other embodiments, management and planning module 32 may be installed on server 30 located in the same local area network as backend systems 12 and/or client 38. In some embodiments, management and planning module 32 may be installed on a single computer or server; in other embodiments, management and planning module 32 may be a distributed application residing on a plurality of devices, including virtual machines. Various hardware and software implementations are possible for management and planning module 32, all of which are encompassed within the broad scope of the embodiments.

Backend systems 12 can include various computers, measuring instruments, public and proprietary software applications and systems and such other hardware and software components that facilitate operating with myriad medical data sources (e.g., hospitals 14, clinics 16, etc.) and communicating medical data 26, operations data 27, services data 28, clinical pathway 34, and services pathway 35 with cloud 29. Backend systems 12 may present various disparate operating systems and platforms to server 30, including EMRs, hospital information systems (HIS), lab and pathology systems (LIS), imaging systems (PACS, RIS), pharmacy systems, scheduling systems, medical devices, etc. In some embodiments, each medical data source may be a separate system, with its own computer network, data format and proprietary applications. In other embodiments, substantially all medical data sources may be part of a single system (e.g., enterprise network, software, etc.) that can interface with each other and with backend systems 12.

Cloud 29 is a collection of hardware and software forming a shared pool of configurable computing resources (e.g., networks, servers, storage, applications, services, etc.) that can be suitably provisioned to provide on-demand self-service, network access, resource pooling, elasticity and measured service, among other features. Cloud 29 may be deployed as a private cloud (e.g., infrastructure operated by a single enterprise/organization), community cloud (e.g., infrastructure shared by several organizations to support a specific community that has shared concerns), public cloud (e.g., infrastructure made available to the general public), or a suitable combination of two or more disparate types of clouds. Cloud 29 may be managed by a cloud service provider, who can provide subscribers (e.g., client 38) with at least access to cloud 29, and authorization to use cloud resources in accordance with predetermined service level agreements.

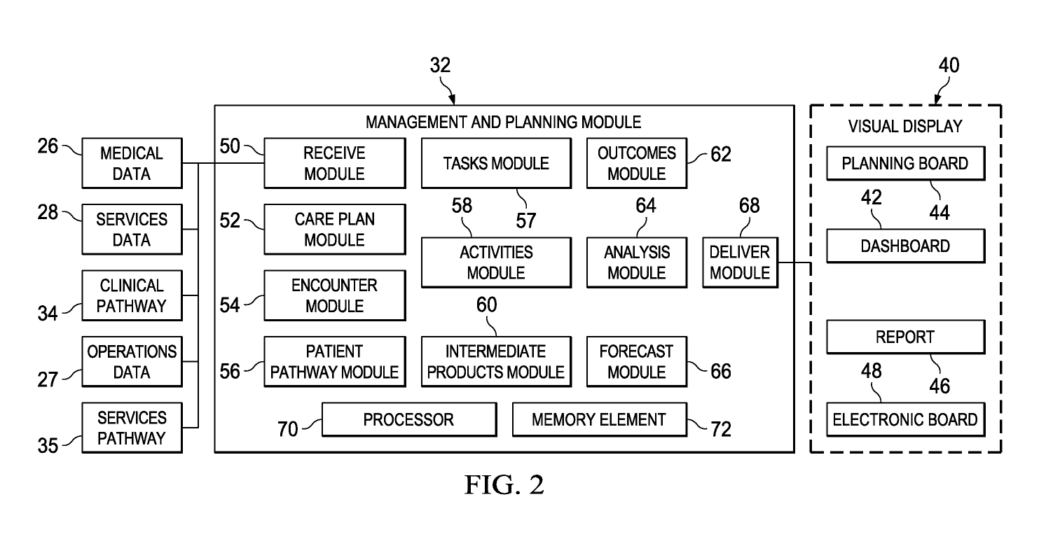

Turning to FIG. 2, FIG. 2 is a simplified block diagram illustrating example details of an embodiment of healthcare monitoring system 10. Management and planning module 32 may include a receive module 50 that is configured to receive data comprising medical data 26, operations data 27, services data 28, clinical pathway 34, and services pathway 35 (among other data). Receive module 50 may be configured with appropriate network interfaces to communicate with backend systems 12 and receive medical data 26, operations data 27, services data 28, clinical pathway 34, and services pathway 35.

Receive module 50 may also include appropriate data transformation modules to transform medical data 26, operations data 27, services data 28, clinical pathway 34, and services pathway 35 from their respective formats (e.g., arrangement of data for storage, display, communication, printing, etc. such as hypertext markup language (HTML), text, and extensible markup language (XML), Microsoft Word (*.doc), Microsoft Excel (*.xls)), etc.) to a uniform format (e.g., data arrangements that can be rendered on a common interface simultaneously, such as HTML format that can permit a web browser to render text and images simultaneously) and store the uniform format data in a data store within cloud 29. In various embodiments, the data store may be appropriately accessible by management and planning module 32. In some embodiments, the data transformation may implement object-relational mapping (ORM) (e.g., automated and transparent persistence of objects to tables in a relational database by using appropriate metadata, which describes mapping between the objects and the database) to convert data between incompatible type systems. In other embodiments, the data transformation may use native procedural language (associated with databases) to perform the conversion from disparate formats to the uniform format.

In some embodiments, the data transformation may implement Extract-Transform-Load (ETL) processes to extract data from the plurality of data sources, transform it appropriately, and load it into the data store in cloud 29. Extracting may involved consolidating data from a variety of data sources having mutually incompatible systems, formats, organization, structure, or procedures. Example systems, formats, organization, structure, or procedures may include relational databases, flat files, Information Management System (IMS), Virtual Storage Access Method (VSAM), Indexed Sequential Access Method (ISAM), web spidering and screen-scraping. Transforming may include applying a series of rules or functions (e.g., parsing, sorting, translating, selecting, concatenating, joining, aggregating, transposing, pivoting, splitting columns and/or rows, validating, etc.) to the extracted data to derive the uniform format data. Loading may include saving the uniform format data into the data store, and can involve overwriting duplicative data, adding data in chronological order (e.g., with timestamps), etc. that take into account constraints (e.g., uniqueness, referential integrity, etc.) of the database schema of data store 84.

A care plan module 52 may generate one or more care plans based on medical data 26, operations data 27, services data 28, clinical pathway 34, and services pathway 35. As used herein, a “care plan” is a programmed plan of action for the medical management or wellness promotion of a given population (e.g., patients in a hospital) or individual (e.g., patient). Care plans can be based on the known level of science within the medical industry. A particular patient may be on multiple care plans depending on his or her medical condition. An aggregated set of care plans for a specific patient may be referred to herein as a “Patient care plan.” According to embodiments of healthcare monitoring system 10, care plan module 52 can provide an integrated framework for population health management and individual patient care delivery across a continuum including tracking and measurement of the cost per unit of service.

Care plan module 52 may also generate a care plan template, which can include a framework of care for a health population with particular characteristic(s) (e.g., Asian, Caucasian), condition (e.g. congestive heart failure), diagnosis (e.g., acute myocardial infarction), or stage in life (e.g. geriatric, infant, etc). The care plan template may include specific role functions and time references. The care plan template may be associated with one or more guidelines (e.g., set of criteria that define evidence based care for a population of patients). The care plan template can include one or more activities and may be created (e.g., authored) within care plan module 52 to be available for use during execution.

Execution of the care plan can include providing medical care to a patient approximately according to a prescribed clinical pathway (e.g., clinical pathway 34) or other suitable guideline (e.g., as prescribed by a physician) as embodied in the care plan template. Typically, execution occurs during an encounter. During execution of the care plan, deviations (due to various reasons) from clinical pathway 34 may be observed. For example, the clinical pathway may prescribe medication X to be provided to the patient; the physician may instead prescribe medication Y. Such deviations may be captured in real time and recorded appropriately in the patient's care plan during execution. Embodiments of healthcare monitoring system 10 can identify such deviations and perform appropriate variance analysis on demand. The care plan in execution may include a care plan template pertinent to a specific problem and potentially for a specific patient or population but not yet individualized at the point of care.

An encounter module 54 may store various encounter types (e.g., physician visit, laboratory visit, etc.) and also record encounters when they occur. In various embodiments, encounter module 54 may trigger activation of various operations of management and planning module 32. A patient pathway module 56 may generate a patient pathway, which can include an instance of service pathway 35 as applied to a particular patient. The patient pathway can include one or more activities and one or more intermediate products and may be created (e.g., authored) within patient pathway module 56 to be available for use during execution. Execution of the patient pathway can include providing services to a patient approximately according to a prescribed services pathway (e.g., services pathway 35) or other suitable guideline (e.g., as prescribed by a physician). Typically, execution of the patient pathway occurs during an encounter. For example, a services pathway 35 for a specific surgical procedure may be modified for a particular patient with diabetes to include a blood-sugar test before and after the surgical procedure. During execution of the patient pathway, the blood-sugar test may be administered on the patient.

A tasks module 57 may include a collection of substantially all tasks that can be performed during treatment of patients or operations of medical care facilities. A task is a smallest unit of an activity. Each task can be categorized as belonging to administrative, clinical, or functional types. Examples of tasks include prescribing a medication (e.g., clinical type), drawing blood (e.g., clinical type), operating specific equipment (e.g., functional type), filling in admissions forms (e.g., administrative type), etc. Tasks can include treatment items (e.g., prescribing medication, performing surgery, etc.) and non-treatment items (e.g., walking the patient's dog, taking vital measurements, etc.).

An activities module 58 may generate activities. An activity can include a collection of one or more tasks that together define the process and protocols of care. The activity can be saved in an activity library within cOS 31, enabling re-use. In one embodiment, activities module 58 may extract one or more activities from medical data 26, operations data 27, services data 28, clinical pathway 34, and services pathway 35. In another embodiment, activities may be extracted from the care plan, and patient pathway. More than one activity may be grouped into an activity bundle, which can form a sequence of activities for a specific procedure (or Intermediate product). The activity bundle can enable reuse of existing individual activities within a care plan template or care plan in execution. Examples of activity bundles include the defined set of activities in the National Health Services (NHS, U.K.) framework, the Nurse Intervention Classification (NIC), Nursing Outcomes Classification (NOC), Fee for Service (FFS), and other user-defined classification schemes.

An intermediate products module 60 may identify intermediate products pertaining to the Service Pathway. In one embodiment, the intermediate products may be identified from medical data 26, operations data 27, services data 28, clinical pathway 34, and services pathway 35 to enable generating the care plan and/or the patient pathway. In another embodiment, the intermediate products may be extracted from the care plan or patient pathway as part of a drill down exercise. An outcomes module 62 may identify one or more clinical, operating and financial outcomes of services provided at a specific medical care facility (or groups of medical care facilities). In a general sense, “outcomes” are the result of the patient's interaction with the medical care facility(ies). Clinical outcomes can include effects of medical care (e.g., a specific treatment, measure, etc.) on patients, such as mortality, length of stay, readmission rates, morbidity measures and unplanned return to the emergency room; operating outcomes can include effects of medical care on the operational metrics of the medical care facility(ies), such as resource shortages, resource utilization, employee complaints, patient complaints, etc.; financial outcomes can include effects of medical care on the financial metrics of the medical care facility(ies), such as costs associated with operating equipment, utility costs, resource costs, revenue generated, etc.

Operating and financial outcomes can include one or more resources in medical data 26, operations data 27, services data 28, clinical pathway 34, and services pathway 35 that can be used in the care plan, and/or the patient pathway. Examples of resources include labor (e.g., physician, nurse, scheduler, administrator, etc.), equipment (e.g., X-ray machine, Magnetic Resonance Imaging (MIR) system, ambulance, beds, etc.), materials (e.g., medication, injectibles, stents, spinal implants, etc.), facilities and fixtures (e.g., surgery, recovery, pre-operation, laboratory), procedures (e.g., chemotherapy) etc. that are associated with a cost per unit time. Resources can have one or more attributes, such as name, type, usage (e.g., in percentage or other unit of measure (UOM)), rate (e.g., cost/time), fixed cost, etc.

Operating and financial outcomes may also include one or more supplies (e.g., clinical supplies, surgical supplies, cleaning supplies, office supplies, food supplies) in medical data 26, operations data 27, services data 28, clinical pathway 34, and services pathway 35 that can be used in the care plan, Services Pathway, and/or the patient pathway. In a general sense, a supply can be a consumable item (e.g., medication) used in the delivery of care and that has a defined (or definable) cost per unit item; the supply can also include a non-consumable item (e.g., high cost surgical equipment) used in the delivery of care and that has a defined (or definable) non-recurring expense and recurring expenses (e.g., costs associated with autoclaving high cost non-consumable equipment).

An analysis module 64 may analyze the clinical, operating and financial outcomes, including performing cost analysis, clinical analysis, etc. to determine a status of the medical care facility and patients therein at the time of the analysis. A forecast module 66 may perform forecasting based on the results of the analysis, for example, to extrapolate to a future time, based on past performance (among other parameters).

According to one embodiment, during configuration, clinical pathway 34 and services pathway 35 may be set up by a system administrator or other suitable user. Templates for patient care plans and patient pathways may also be set up by the system administrator or other suitable user. Resources, supplies and costs may be generated when the templates for the care plans and patient pathways are set up. The patient care plans and patient pathways can be run in a simulation mode by reading in an appointment calendar of patients from a suitable calendaring tool available through operations data 27. The appointment calendar can indicate a known demand. An unknown demand may also arise from customers coming through Emergency Response (ER) or other departments (e.g., OB-Gyn, neonatal care unit, etc.). Such unknown demand may be included statistically, heuristically, and (or alternatively) based on real time data.

Graphs for resources against costs (e.g., time and money (e.g., salaries for human, operating costs for facilities, fixed costs for equipment)) may be loaded on dashboard 42 (or planning board 44, or report 46) showing utilization of resources and associated costs. Cost load graphs may be displayed for materials. Revenue and costs associated with each Service Pathway may also be displayed, for example, to indicate profitability. Financial information may be shown by organization, location, department, service line (e.g., cardio, orthopedics, etc.) etc., across the medical care facility. The financial information displayed may assist a user in determining a cost accounting basis for assets and revenue.

In various embodiments, medical data 26, operations data 27, services data 28, clinical pathway 34, and services pathway 35 in real time may be used to perform real time analytics related to care plans and patient pathways, which can be used for clinical analysis, and expanded to clinical-financial and regulatory fields. An execution and simulation engine (e.g., based on practices of lean and six-sigma) may also be added to management and planning module 32 based on particular implementation setups, with off-line mode for planning and on line mode to track real patient flow across the points of care. Management and planning module 32 may execute off of processor 70 and memory element 72. A deliver module 68 may deliver information for visual display 40 at client 38.

In some embodiments, activities may be based on care plans according to treatment type. Care plans can drive the patient flow through a pull based process. As activities are completed, the patient moves to next set of activities on the care plan. The roles responsible for those activities may be notified. Exception conditions may be defined based on dependency between the tasks. Dependencies can be time based. Documentation of the clinical data may be decision tree driven. Appropriate user interfaces (UI) may be rendered based on user choices. Resources and Bill of materials can be associated with tasks or activities. A series of dashboards specific to the roles may be generated.

According to an embodiment, a browser of client 38 may send a request to management and planning module 32 requesting one or more of dashboard 42, planning board 44, report 46, and electronic board 48. In some embodiments, management and planning module 32 may access medical data 26, operations data 27, services data 28, clinical pathway 34, and services pathway 35 in real time, modify the configured care plans and patient pathways, and render visual display 40 accordingly. In other embodiments, management and planning module 32 may access medical data 26, operations data 27, services data 28, clinical pathway 34, and services pathway 35 stored in the data store in cloud 29, modify the configured care plans and patient pathways and render visual display 40 accordingly. In yet another embodiment, management and planning module 32 may access medical data 26, operations data 27, services data 28, clinical pathway 34, and services pathway 35 (in real time or from the data store), and generate care plans and patient pathways accordingly (e.g., based on preferences, rules, or guidelines preconfigured in management and planning module 32 by a system administrator).

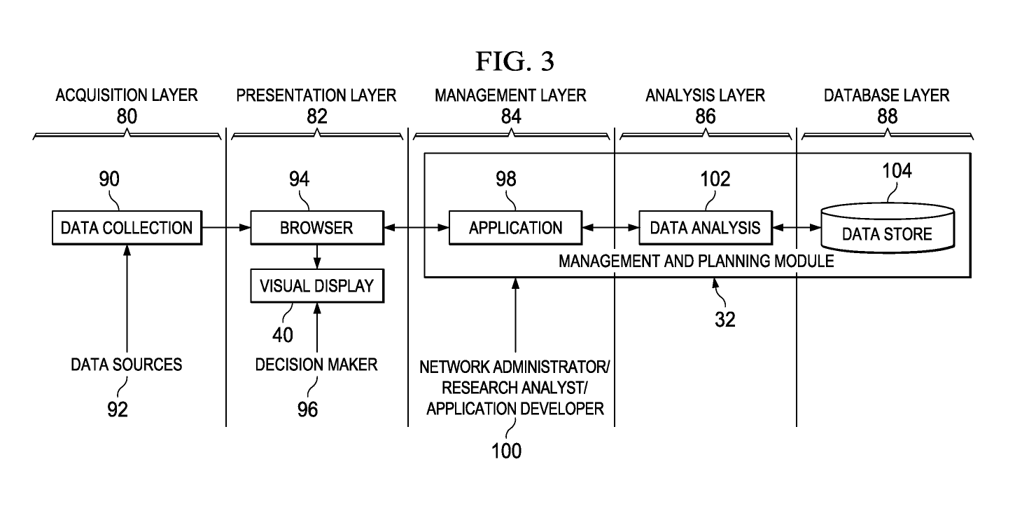

Turning to FIG. 3, FIG. 3 is a simplified diagram illustrating example details of an embodiment of healthcare monitoring system 10. In an example embodiment, healthcare monitoring system 10 may be implemented in several layers, including an acquisition layer 80, a presentation layer 82, a management layer 84, an analysis layer 86 and a database layer 88. Data collection 90 in acquisition layer 80 may involve collecting data, including medical data 26, operations data 27, services data 28, clinical pathway 34, and services pathway 35, from one or more medical data sources 92. Medical data sources 92 may include hospitals, physicians, laboratories, healthcare facilities, patients, and other caregivers and associated entities that can provide data for data collection 90. Browser 94 (e.g., in client 38) in presentation layer 82 may enable visual display 40 to a decision marker 96 (e.g., physician, patient, etc.). Browser 94 may enable displaying data collected by data collection 90, enabled by an application 98 in management layer 84. Application 98 may be accessed, controlled and/or configured by a network administrator/research analyst/application developer 100. Application 98 may interact with a data analysis 102 in analysis layer 86, which may use data stored in a data store 104 in database layer 88. In the example embodiment illustration in the FIGURE, management and planning module 32 may comprise application 98, data analysis 102 and data store 104 in management layer 84, analysis layer 86, and database layer 88, respectively.

In the example embodiment, database layer 88 may facilitate building a clinical and operations data warehouse comprising medical data 26, operations data 27, services data 28, clinical pathway 34, and services pathway 35. Data analysis 102 may comprise analysis using statistical tools, algorithms, data mining and other functions to enable the operations described herein. In some embodiments, analysis layer 86 may include database and application servers with remote computation or offline data mining capabilities. Application 98 in management layer 84 may control and manage the flow of data from data collection 90 to data store 104, and back to visual display 40. A management interface may be configured with application 98 to data access functions for users 36, for example, to enable visual display 40.

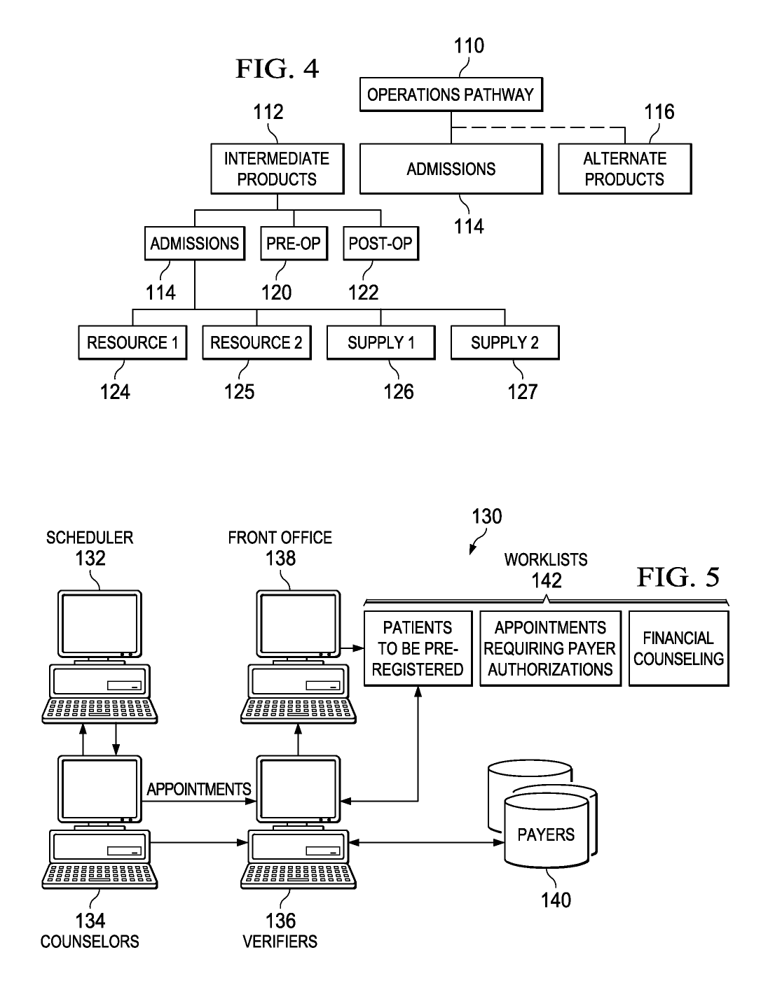

Turning to FIG. 4, FIG. 4 is a simplified block diagram illustrating a simplified Services Pathway 35 associated with an operation (e.g., surgery) according to an embodiment of healthcare monitoring system 10. Operations Pathway 110 may include intermediate products 112, admissions 114 and alternate products 116. For example, the Operations service line may be broken down into admissions 114, wherein patients are initially admitted to the medical care facility; alternate products 116 may include alternatives to surgery, which may be communicated to the patient (e.g., by law, regulations, guidelines, best practices, etc.) Intermediate products 112 may include admissions 114, relating to admissions to the surgery facility. Intermediate products 112 may also include pre-op 120 and post-op 122. In pre-op 120, the patient may be prepared for surgery; in post-op 122, the patient may be monitored after surgery. Each step may involve one or more resources. For example, admissions 114 may include resources 124 and 125 (e.g., computer and administrative personnel) and supplies 126 and 127. Further breakdown of each Service Pathway 35 into one or more resources, and associated costs may be implemented within the broad scope of the embodiments.

Turning to FIG. 5, FIG. 5 is a simplified block diagram illustrating an example patient referral process according to an embodiment of healthcare monitoring system 10. In the example scenario depicted in the FIGURE, patients may be referred from clinics to the surgery centers. The referral process can include a series of administrative, clinical and functional (e.g., automated) tasks performed by certain roles. Example activities and task include: verify patient demographics; verify insurance; check patient current medications; and trigger eligibility verification and analyze the response. The referral process may be a collaborative process that can involve clinical activities and other activities. The activities and tasks can be stringed into a care plan.

For example, a scheduler 132 may receive a call from a patient asking to schedule an appointment for a surgery. Scheduler 132 may enter the appointment in an appointment calendar. The entry may trigger a series of operations. A counselor 134 may check the patient's current medications and verify that the medical care facility would have the required supplies on the appointed date. A verifier 136 and a front office 138 may verify the patient's demographics and insurance, for example, with payers 140. Verifier 136 may create one or more worklists 142.

Worklists 142 may include a list of patients to be pre-registered, another list of appointments requiring payer authorization, yet another list of patients requiring financial counseling, etc. The examples of worklists are merely for illustrative purposes, and are not intended to be limitations. Worklists 142 may include a hierarchical structure, for example, that organizes objects (e.g., patients) under object types (e.g. data elements, program texts, etc.), that are in turn organized according to object groups sorted according to priority in the worklist structure. Worklists 142 may be included in any suitable form, format, data structure or other organized mechanism within the broad scope of the embodiments. Worklists 142 may be presented to (or retrieved when needed by) front office 138 (e.g., when the patient presents himself or herself on the appointed day).

The various modules, namely, scheduler 132, counselor 134, verifier 136 and front office 138, may be part of management and planning module 32 in an example embodiment of healthcare monitoring system 10. In another example embodiment, scheduler 132, counselor 134, verifier 136 and front office 138 may be part of backend systems 12 and may suitably interface with management and planning module 32. In yet another example embodiment, scheduler 132, counselor 134, verifier 136 and front office 138 may be part of client 38, and may suitably interface with management and planning module 32 to perform the operations described herein. Scheduler 132, counselor 134, verifier 136 and front office 138 may include appropriate software and hardware for performing the operations described herein.

Turning to FIG. 5, FIG. 5 is a simplified block diagram illustrating another example patient referral process according to another example embodiment of healthcare monitoring system 10. Example process 150 may include a clinic 152, which may access a portion of cOS 31. An ambulatory surgical center (ASC) 154 may also access another portion of cOS 31. Note that clinic 152 and ASC 154 are provided herein merely as examples of medical care facilities. Any medical care facility may be included herein within the broad scope of the embodiments of healthcare monitoring system 10. Moreover, although cOS 31 is shown herein as being accessed by both clinic 150 and ASC 154, the portions of cOS 31 accessed by clinic 150 and ASC 154, respectively, may be located in separate and distinct locations and network, or may be located in the same network.

Management and planning module 32 in cOS 31 may generate a care plan 156, including determining if surgery is required, filling out ASC request form, verifying eligibility, attaching clinical data to the request form, requesting a preferred date for the surgery, and sending the request in a patient referral packet to the portion of cOS 31 accessed by ASC 154. cOS 31 accessed by ASC 154 may be configured to transform information from the patient referral packet to care plan 158, which can include obtaining authorization, verifying clinical details like medications, orders and laboratory results, ensuring patient meets surgical criteria, verifying necessity of surgery, scheduling the patient for surgery, obtaining financial clearance, and performing pre-surgical assessment. Clinic 152 and ASC 154 may collaborate further as desired on additional information. For example, ASC 154 may request additional information, and clinic 150 may provide the additional information, if available. ASC 154 may send a patient schedule confirmation to clinic 152 when the surgery is scheduled on a suitable appointment calendar.

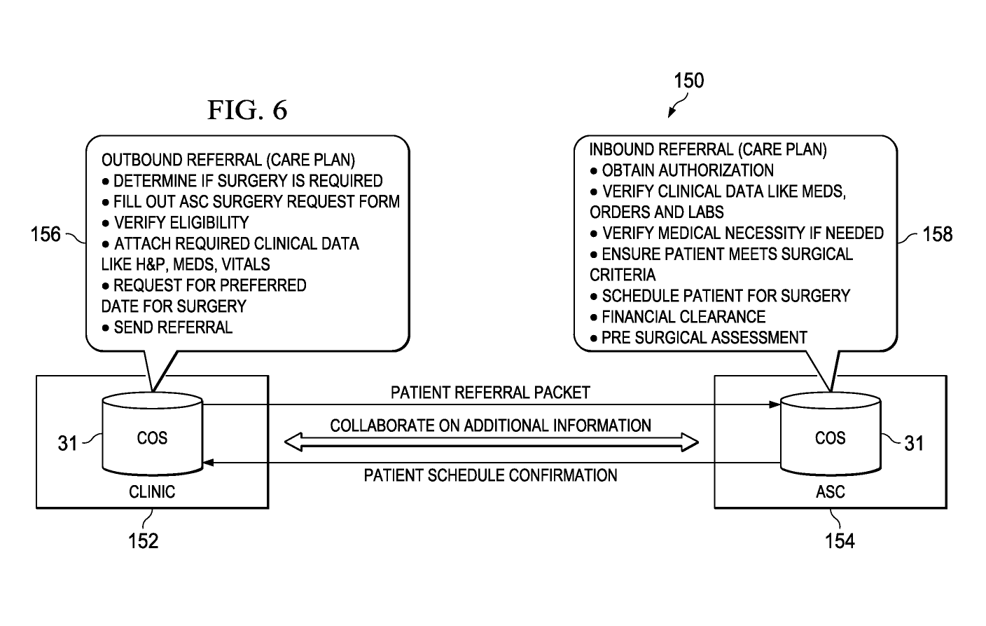

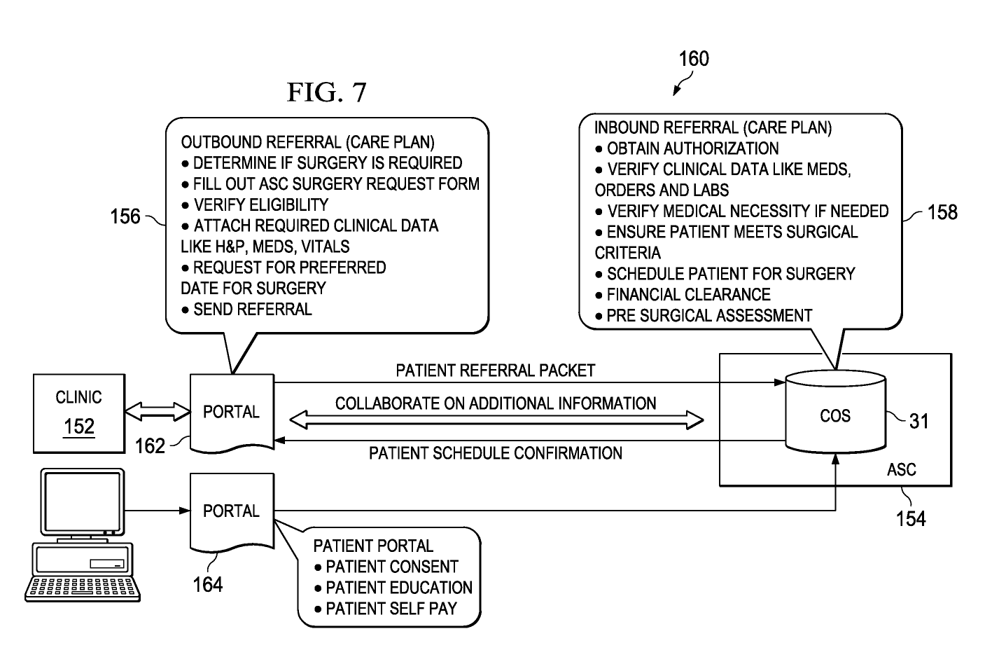

Turning to FIG. 6, FIG. 6 is a simplified block diagram illustrating yet another example patient referral process according to another example embodiment of healthcare monitoring system 10. Example process 160 may include clinic 152, which may access a portal 162 (e.g., web portal, such as an Internet browser), through which clinic 152 can access ASC 154. Patients may also separately access ASC 154 using a patient portal 164. ASC 154 may access a portion of cOS 31. Note that clinic 152 and ASC 154 are provided herein merely as examples of medical care facilities. Any medical care facility may be included herein within the broad scope of the embodiments of healthcare monitoring system 10.

Clinic 152 may generate (by any suitable means, such as manual intervention, appropriate software, etc.) outboard care plan 156, including determining if surgery is required, filling out ASC request form, verifying eligibility, attaching clinical data to the request form, requesting a preferred date for the surgery, and sending the request in a patient referral packet to the portion of cOS 31 accessed by ASC 154. cOS 31 accessed by ASC 154 may be configured to transform information from the patient referral packet to care plan 158, which can include obtaining authorization, verifying clinical details like medications, orders and laboratory results, ensuring patient meets surgical criteria, verifying necessity of surgery, scheduling the patient for surgery, obtaining financial clearance, and performing pre-surgical assessment. Clinic 152 and ASC 154 may collaborate further as desired on additional information through portal 162. For example, ASC 154 may request additional information, and clinic 150 may provide the additional information, if available. ASC 154 may send a patient schedule confirmation to clinic 152 when the surgery is scheduled on a suitable appointment calendar. The patient may be able to provide consent, learn about the surgery, and pay through patient portal 164.

In various embodiments, portal 162 and patient portal 164 may be part of management and planning module 32. In other embodiments, portal 162 and patient portal 164 may be part of medical data sources, backend systems 12, and/or client 38, as appropriate. Management and planning module 32 of embodiments of healthcare monitoring system 10 may be configured to interface with electronic data from virtually any medical care facility, in virtually any format and generate suitable visual display 40 according to predetermined needs and settings.

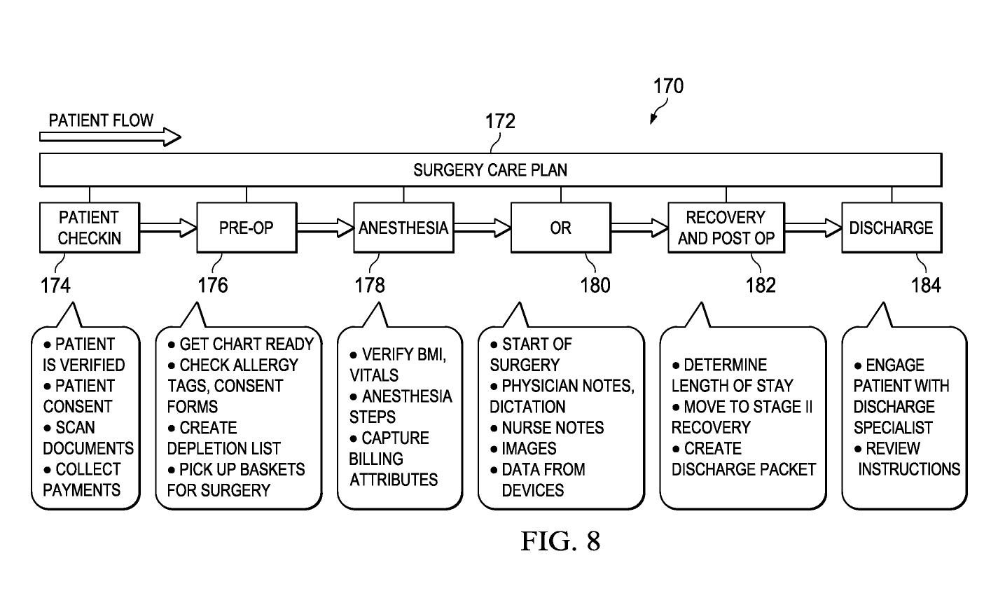

Turning to FIG. 8, FIG. 8 is a simplified block diagram illustrating an example surgery care plan 172 according to an embodiment of healthcare monitoring system 10. Surgery care plan 172 may include several activities or intermediate products, including patient check-in 174, pre-op 176, anesthesia 178, operations 180, recovery and post-op 182, and discharge 184. At patient check-in 174, the activities may include verifying the patient, obtaining the patient's consent, scanning documents, and collecting payment. At pre-op 176, the activities may include getting a chart ready, checking allergy tags and consent forms, creating depletion lists, and picking up baskets for surgery.

At anesthesia 178, the activities can include verifying body mass index (BMI), performing the anesthesia steps, and capturing billing attributes. At OR 180, the activities can include performing the surgery, capturing physician notes, dictation, nurse notes and images. At recovery and post-op 182, the activities can include determining a length of stay, moving to the next stage in the recovery process, and creating a discharge packet. At discharge 184, the activities can include engaging the patient with a discharge specialist, and reviewing instructions for post operative care.

According to various embodiments, management and planning module 32 may generate surgery care plan 172 (e.g., based on preconfigured set of activities or from medical data 26, operations data 27, services data 28, clinical pathway 34, and services pathway 35 according to preconfigured rules or settings). In some embodiments, surgery care plan 172 may be tailored for a specific patient, and resource and cost information may be derived therefrom. Surgery care plan 172 shown and described herein is merely for example purposes, and is not intended to be a limitation. Various services provided to the patient (or patient population) may include other care plans, with appropriate activities that pertain to the respective service. Some services may share activities (e.g., patient check-in 174 may be common to more than one care plan), and some services may have unique activities (e.g., OR 180 may be unique to surgery) that are not shared by any other care plan.

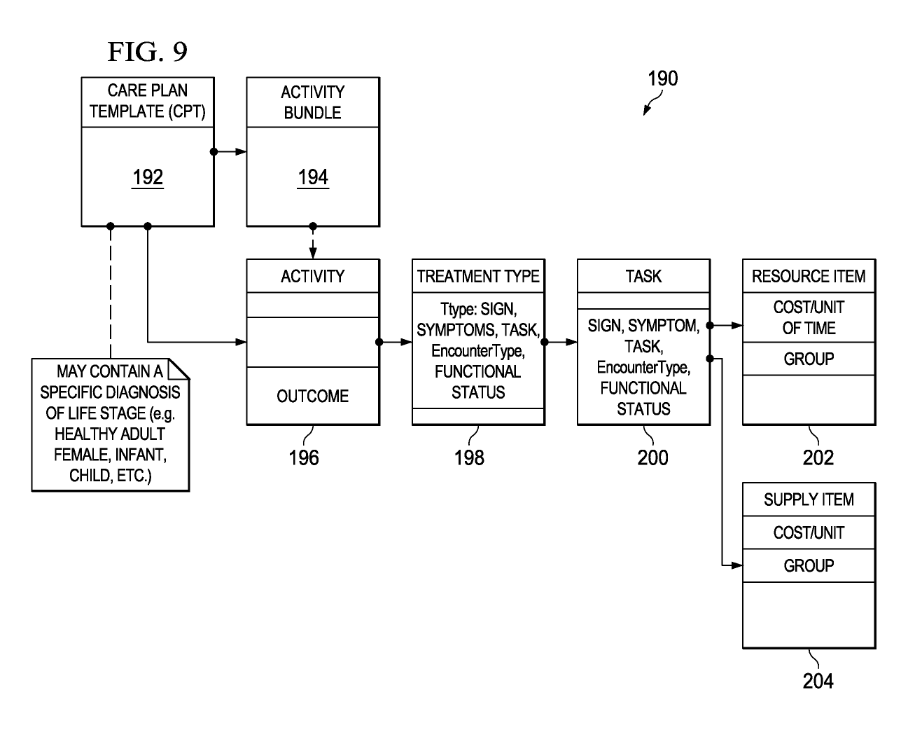

Turning to FIG. 9, FIG. 9 is a simplified block diagram illustrating a logical view of relationships 190 between various components of management and planning module 32 according to embodiments of healthcare monitoring system 10. A care plan template 192 may be preconfigured in management and planning module 32 based on relationships 190 according to some embodiments of healthcare monitoring system 10. Care plan template 192 may be associated with one or more activity bundle(s) 194 (e.g., many activity bundles may be included in one care plan template). Care plan template 192 and each activity bundle 194 may be associated with one or more activity(ies) 196 (e.g., many activities may be included in one care plan template or one activity bundle).

Each activity 196 may be associated with one or more treatment type(s) 198 that may relate to one or more task(s) 200. Task 200 may constitute the smallest measurable unit within the care plan framework in embodiments of healthcare monitoring system 10. Task 200 may be categorized as a treatment item or a non-treatment item. A treatment item can represent a specific task 200 associated with activity 196 that is of a clinical nature (e.g., activity 196 can include a blood work on a patient that includes tasks such as preparing the patient's hand, preparing the syringes, preparing the centrifuge or other equipment for taking measurements, obtaining blood from the patient, measuring blood constituents, etc.). A sequence of tasks 200 in a specific order can define a protocol (e.g., procedure, practice, sequence of steps, etc.) to be followed for performing activity 196. Each task 200 may be categorized according to treatment type 198 (e.g., each treatment type may be associated with more than one tasks). Examples of treatment type 198 include Labs; Images; Medications; Procedures; Vitals; Signs; Symptoms; Encounter; Functional Status, etc. Depending on treatment type 198, task 200 may have both a current measurement (e.g., value) as well as one or more goals (e.g., expected measurement) when used as part of a patient's care plan. Each task 200 may be associated with one or more resource item 202, and one or more supply item 204.

Each task 200 may be associated with an encounter type having a frequency associated with encounters, and the task can trigger generation of reminders appropriately (e.g., according to the frequency). For example, an encounter type of appointment can generate a reminder regarding the appointment. In another example, an encounter type of a laboratory visit to measure blood sugar level can generate a reminder every day at the prescribed time to fulfill the laboratory visit.

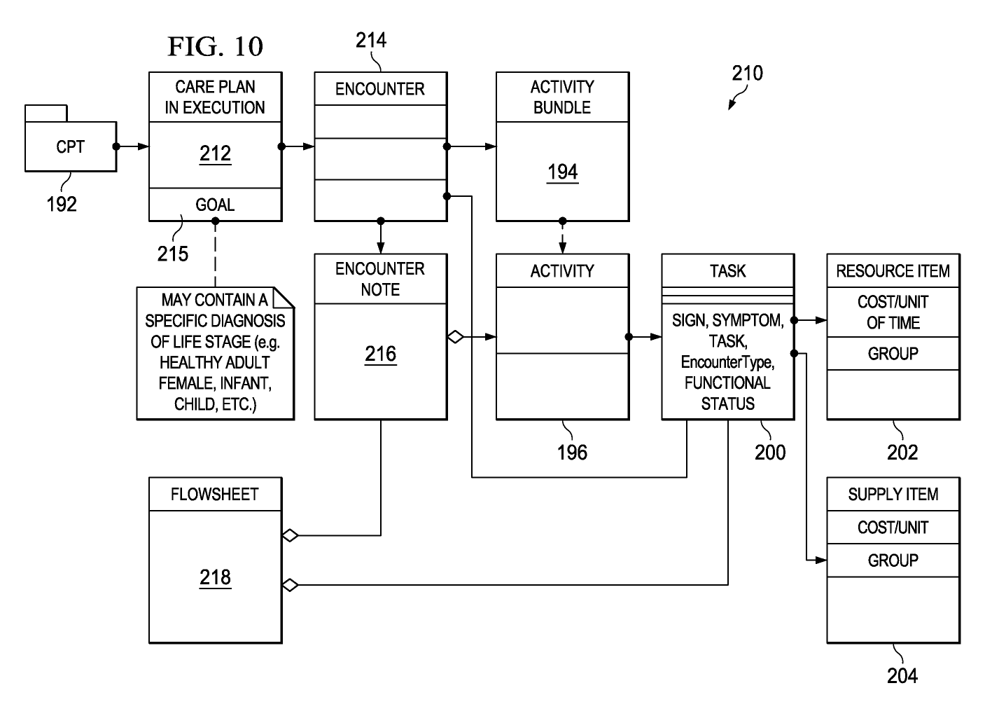

Turning to FIG. 10, FIG. 10 is a simplified block diagram illustrating a logical view 210 of a care plan execution according to embodiments of healthcare monitoring system 10. Care plan template 192 may be executed by a care plan in execution 212 during one or more encounters. At any point in time, a patient whose information is available in healthcare monitoring system 10 may be associated with care plan template 192 to generate a care plan in execution 212 for the patient. Associating the patient with care plan template 192 can include linking a specific care plan template 192 (e.g., configured for a specific diagnosis, such as heart disease, diabetes, pregnancy, etc.) with the patient's identifier (e.g., name, or social security number, etc.). For example, the patient may have heart problems and diabetes, and may be admitted to the medical care facility following a heart attack. The patient may be previously associated with a first care plan template 192 related to heart problems and a second care plan template 192 related to diabetes in healthcare monitoring system 10. In one embodiment, care plan in execution 212 may combine information from both the first and second care plan templates. In other embodiments, care plan in execution 212 during the patient's treatment at the medical care facility may be related to heart problems only (and another medical care facility may be associated with the care plan in execution 212 related to diabetes). In some cases, the patient may be newly diagnosed with blood pressure. A new care plan in execution 212 may be generated for the patient during the patient's first encounter concerning blood pressure. In various embodiments, appropriate medical and operational guidelines may be considered during execution of care plan template 192.

During operation, care plan in execution 212 may be associated with one or more encounter(s) 214 by care plan module 52. (An encounter can include an event occurring between a patient and provider or between providers on behalf of a patient. Examples of encounters include an appointment with a health care provider, a referral between a doctor and a specialist, etc.). For example, the patient checks into the medical care facility presenting symptoms of heart disease. The patient's care plan in execution 212 may be associated with (e.g., linked to, connected with, etc.) one or more encounters with health care practitioners at the medical care facility during the course of the patient's treatment at the facility. In some embodiments, the association may be based on medical data 26, operations data 27, services data 28, clinical pathway 34, and services pathway 35. For example, a diabetic patient may measure blood sugar levels at home, and enter the values through an online portal in healthcare monitoring system 10, generating medical data 26, which may trigger creating encounter 214 and associating the patient's care plan in execution 212 with encounter 214.

Care plan in execution 212 may include one or more goals 215 associated with encounter 214, or the patient, or both. Goals 215 may include expected clinical outcomes for the patient, among other parameters. Goals 215 can also include operational goals, such as expected length of stay at the medical care facility, among other parameters. Goals 215 can also include financial goals, for example, the patient's (or the provider's) budget associated with care plan in execution 212.

Care plan module 52 in management and planning module 32 may associate each encounter 214 with a respective encounter note 216 during execution of care plan in execution 212. Encounter note 216 can be a structured clinical communication between the patient and provider or by a provider concerning a patient. Because the scope of the encounter extends beyond the patient/clinician relationship, encounter note 216 can have a broader scope than a clinical note and may cover the entire continuum of care regardless of the care provider role or care organization.

One or more encounter note(s) 216 may be consolidated into a flowsheet 218. In a general sense, flowsheet 218 can include a consolidation of individual patient care plans where duplicate items (such as labs and procedures) may be removed. A visual representation of flowsheet 218 may be enabled in some embodiments of healthcare monitoring system 10 (e.g., on visual display 40), that can include specific time referenced reports or graphs (e.g., historical view of blood pressure measurements).

Care plan module 52 in management and planning module 32 may associate each encounter 214 with one or more activity bundles 194 and one or more task(s) 200 (depending on treatment type 198). For example, an encounter with a primary care physician for a routine medical check up can include activities such as measuring blood pressure and heart rate, laboratory work, chest x-ray, etc. Each such activity can be associated with the encounter “routine medical check up.” Some activities can be associated with task(s) 200. For example, activity “measure blood pressure” can be associated with one or more tasks related to blood pressure, for example, counseling the patient on diet to lower blood pressure, prescribing medication to lower blood pressure, etc.

In some embodiments, associating activity 196 with task(s) 200 may be based on medical data 26, operations data 27, services data 28, clinical pathway 34, and services pathway 35. In a specific embodiment, associating activity 196 with task(s) 200 may include selecting one or more of medical data 26, operations data 27, services data 28, clinical pathway 34, and services pathway 35 and determining whether or not to associate (and what to associate) based on the information collected from the selection. For example, the measured value of the blood pressure may be recorded as medical data 26. If medical data 26 indicates that a preconfigured threshold is exceeded (e.g., high blood pressure symptoms), task(s) 200 suitable for lowering blood pressure may be associated with the activity; if medical data 26 indicates that the preconfigured threshold is not exceeded, such task(s) 200 may not be associated with the activity. In another example, task(s) 200 may be based on service pathway 35 available for the medical care facility. For example, a specific medical care facility may have a state of the art instrument for diagnosing and treating a particular disease. Task 200 (or activity 196) associated with the instrument may be made available through the medical care facility's service pathway 35 for the patient.

Care plan module 52 in management and planning module 32 may associate each encounter note 216 with one or more activity(ies) 196. Encounter note 216 may be specific to activity 196, but need not necessarily relate to activity bundle 194. As each task 200 is populated during execution, resource item(s) 202 and supply item(s) 204 may be populated accordingly. According to various embodiments, patient care plan may be generated by associating the patient with care plan template 192 to generate care plan in execution 212, associating care plan in execution 212 with encounter 214, associating encounter 214 with at least one activity 196 (through an activity bundle 192 in some embodiments), associating activity 196 with at least one task 200, and specifying (e.g., selecting, prescribing, populating a suitable field, etc.) task 200 during encounter 214.

In an example scenario, a patient may be admitted to a medical care facility with a fever. The patient may be associated with care plan template 192, which may comprise a generic set of available activities associated with medical conditions presenting fever as a symptom. The patient's association with care plan template 192 may result in a patient care plan that is individualized to the patient. In a general sense, the patient care plan, at this stage, is the generalized care plan template 192 individualized with the patient's name or other identifier. Encounter 214 may include the patient's admission and subsequent examination by a physician. The physician may pull up the patient care plan during encounter 214. The physician may enter some observations regarding the patient's condition in encounter note 216. The physician may also select a specific activity 196, for example, “medication,” from activity bundle 194, for example, “treatment measures.” Task 200 for the activity may include a list of medications, dosages and dosage types. The physician may select a specific medication (e.g., acetaminophen) and specific dosage to be provided intravenously, locking in task 200. The selection may trigger resource item 202, which may pull up the cost and availability of the nurse who can administer the medication. Task 200 may also trigger supply item 204, a consumable syringe and medication, along with the costs associated therewith. At the end of the process, the patient care plan for encounter 14 may include only the selections authorized by the physician; substantially all other activities listed in care plan template 192 may be removed or deselected therefrom. The selections may be populated in the patient care plan and saved for future use.

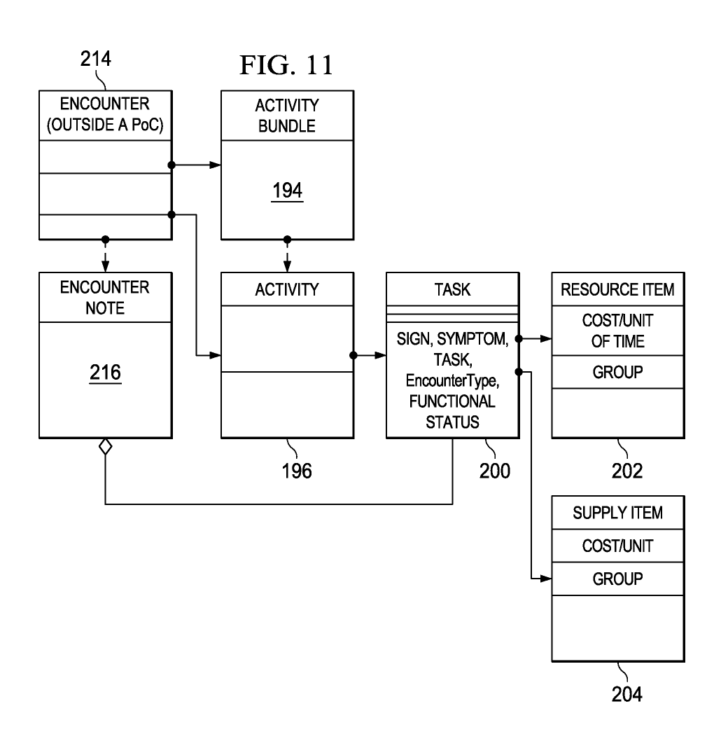

Turning to FIG. 11, FIG. 11 is a simplified block diagram illustrating a logical view of relationships between various components of management and planning module 32 according to embodiments of healthcare monitoring system 10. In an example scenario, a patient may meet with a care provider for a first time, and there may be no previous history or knowledge of the patient in healthcare monitoring system 10. Thus, care plan template 192 for the patient may not be configured. During the meeting with the care provider, a new account may be activated, and encounter 214 outside the care plan context may be generated. Encounter 214 may be associated with encounter note 216, and activity bundle 194. Encounter 214 may also be associated with each activity 196 (as there may be insufficient history on the patient to generate an appropriate activity bundle). Encounter note 216 may be associated with task 200 (rather than activity 196), to ensure fine grain data capture in encounter note 216. Resource item 202 and supply item 204 may be populated based on the specific details of task 200.

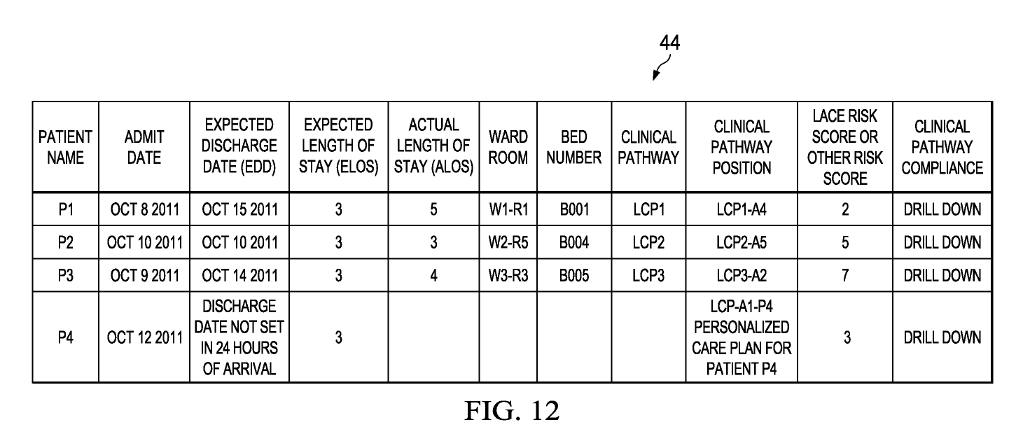

Turning to FIG. 12, FIG. 12 is a simplified diagram illustrating an example planning board 44 according to embodiments of healthcare monitoring system 10. Example planning board 44 includes information relevant to operations of the medical care facility, including a chart having fields corresponding to the patient's name, admit date, expected discharge date, expected length of stay, actual length of stay, ward and room, bed number, clinical pathway name, clinical pathway position, risk score, and clinical pathway compliances.

Example planning board 44 may provide a summarized view of real time data captured during execution of a patient care plan, and can include a drill-down option to review details of the real time data. For example, the real time data may indicate an actual length of stay, with a link to drill down into details of treatment measures provided to the patient during the actual length of stay. The drill-down may reveal problems or issues relevant to the operations of the medical care facility. Example planning board 44 may be useful to a ward manager, for example, to determine how well utilized the ward facilities are, whether patients in the ward are receiving care according to their individual clinical pathways as embodied in the care plans, whether administrative functions are being carried out appropriately, etc.

Various other fields and formats may be used for Planning Board 44 within the broad scope of the embodiments. For example, Planning Board 44 may also include charts, tables, diagrams, graphs, etc. that can provide information in real time and facilitate planning operations, resource allocation, and other management aspects of the medical care facility.

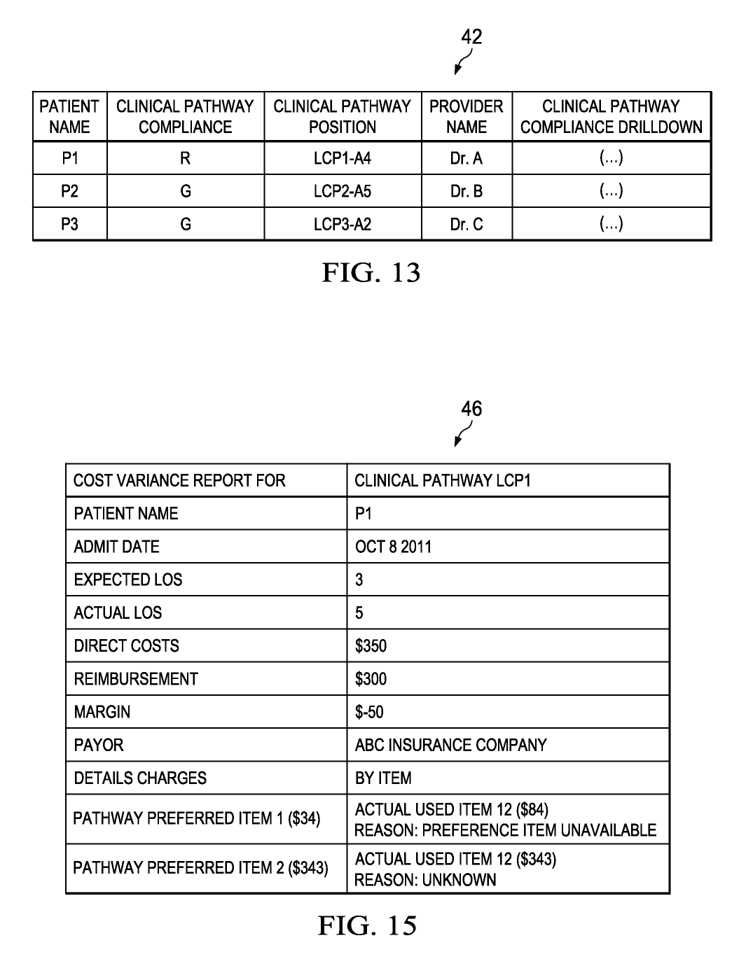

Turning to FIG. 13, FIG. 13 is a simplified diagram illustrating an example dashboard 42 according to embodiments of healthcare monitoring system 10. Example dashboard 42 may provide a suitable summarized chart displaying relevant information for a chief medical officer (CMO) of the medical care facility. Example dashboard 42 may include clinical information associated with a plurality of patients at the medical care facility. Example dashboard 42 may include clinical pathway compliance for each patient in real time and alerts based on clinical pathway violations. In a general sense, dashboard 42 may correspond to a role of the user who has logged into healthcare monitoring system 10 to view example dashboard 42. For example, when the CMO logs in, example dashboard 42 may be displayed. If the chief financial officer (CFO) logs in, the view that he or she would see may be different from example dashboard 42.

In example dashboard 42, the CMO may see the patient's name (or other identifier), and summarized information related to clinical pathway compliance. A drill down option to view details of the clinical pathway compliance may also be provided. Note that various other fields and formats may be used for dashboard 42 within the broad scope of the embodiments. For example, dashboard 42 may also include charts, tables, diagrams, graphs, etc. that can provide information in real time and facilitate compliance with clinical pathways and other guidelines of the medical care facility.

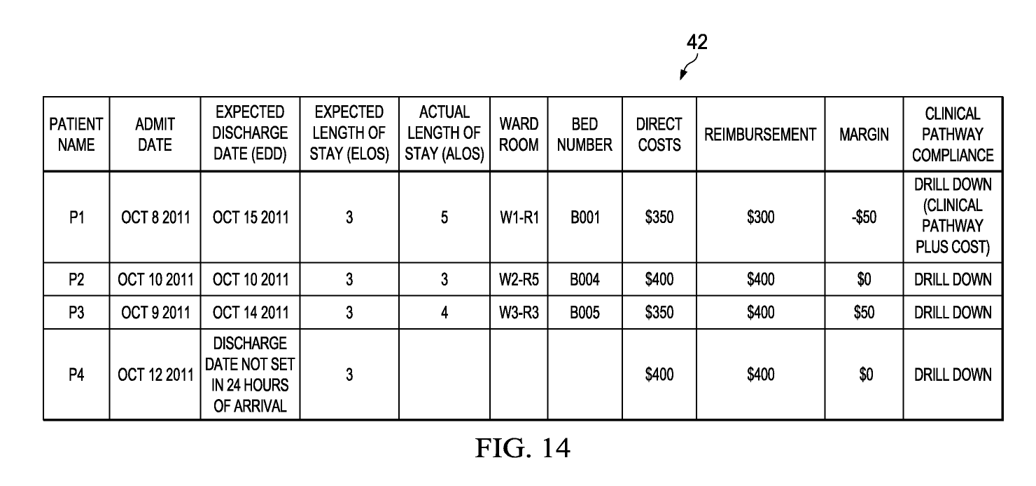

Turning to FIG. 14, FIG. 14 is a simplified diagram illustrating another example dashboard 42 according to embodiments of healthcare monitoring system 10. Example dashboard 42 may provide a suitable summarized chart displaying relevant information for a CFO of the medical care facility. Example dashboard 42 may include fields relevant to obtaining a snapshot (e.g., summarized view) of the financial health of the medical care facility. For example, example dashboard 42 may show available capacity with resource loading for the day based on the patient schedules and real time data; material depletion for the day based on the patient schedules and real time data; etc. In an example embodiment, example dashboard 42 for the CFO may be generated from resource item 202 and supply item 204 populated for each care plan associated with each patient. Other cost measures may also be obtained, for example, from operations data 27.

Note that various other fields and formats may be used for dashboard 42 within the broad scope of the embodiments. For example, dashboard 42 may also include charts, tables, diagrams, graphs, etc. that can provide information in real time and facilitate financial analysis of the medical care facility's accounts.

Turning to FIG. 15, FIG. 15 is a simplified diagram illustrating an example report 46 according to embodiments of healthcare monitoring system 10. Example variance report 46 may indicate a variance from expected costs and/or preferred items (e.g., resource items or supply items) and the reasons for the variance. For example, example variance report 46 may report on a deviation from any activity, task, treatment item, resource item, supply item, etc. that was prescribed by clinical pathway 34 for the patient. Various other kinds of reports 46 may be generated and displayed within the broad scope of the embodiments of healthcare monitoring system 10.

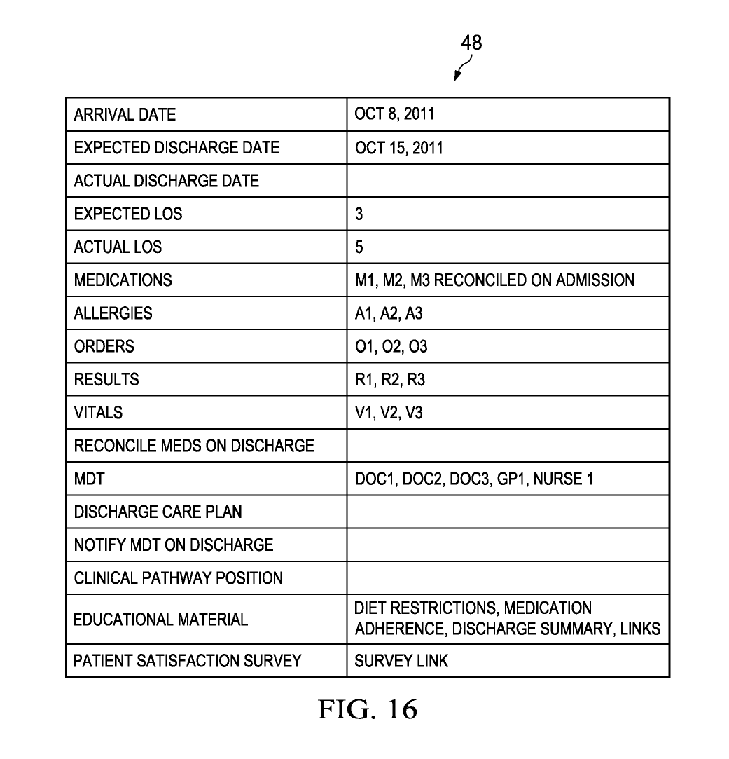

Turning to FIG. 16, FIG. 16 is a simplified diagram illustrating am example electronic board 48 according to an embodiment of healthcare monitoring system 10. Example electronic board 48 may be accessible in a patient's room, and may provide various information to the patient, including education (e.g., on disease, condition, treatment, etc.) in addition to details of the care plan (e.g., what activities are scheduled, etc.). Note that various other fields and formats may be used for electronic board 48 within the broad scope of the embodiments. For example, electronic board 48 may also include charts, tables, diagrams, graphs, etc. that can provide information on the patient's medical condition or care plan.

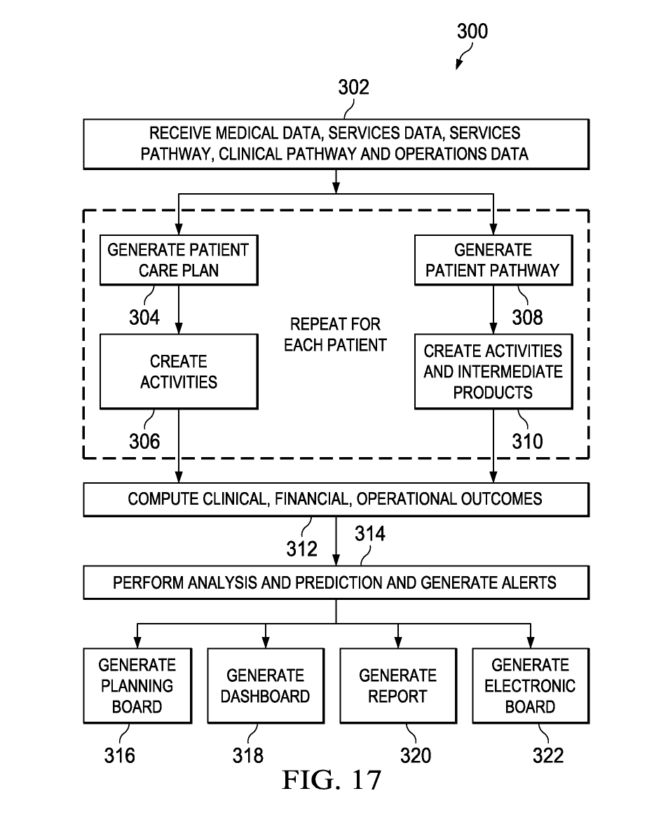

Turning to FIG. 17, FIG. 17 is a simplified flow diagram illustrating example operations 300 that may be associated with embodiments of healthcare monitoring system 10. At 302, medical data 26, operations data 27, services data 28, clinical pathway 34, and services pathway 35 may be received at management and planning module 32. At 304, care plan module 52 may generate a patient care plan based on care plan template 192 and/or care plan in execution 212 for a specific patient. At 306, activity(ies) 196 may be created (e.g., generated, selected, identified, recognized, associated, etc.) according to clinical pathway 34. Additionally at 308, a patient pathway for the specific patient may be generated based on medical data 26, operations data 27, services data 28, clinical pathway 34, and services pathway 35. Activities and intermediate products may be created at 310 according to services pathway 35. Operations 304-310 may be repeated for each patient at the medical care facility.

At 312, clinical, operational, and financial outcomes may be computed from an aggregate of information associated with the activities and intermediate products created at operations 306 and 310 for substantially all patients at the medical care facility. Computing the financial outcomes can include determining costs associated with the resources and/or supplies associated with the activities and intermediate products created at 306 and 310. Computing the operational outcomes can include extracting operations data 27 associated with the resources and/or supplies related to the activities and intermediate products created at 306 and 310. Computing the clinical outcomes can include determining whether goals 215 in the patient care plan have been met. Computing the clinical outcomes can further include extracting medical data 26 related to the patient care plan.

At 314, analysis and prediction may be performed on the clinical, operating and financial outcomes extracted at 314, and suitable alerts may be generated. The analysis can include a mathematical operation of breaking down costs (e.g., in terms of money, time, effort, or other appropriate unit of measure) of some operations and reporting on each break down appropriately, or comparing actual measurements (e.g., in terms of money, time, effort, scientific/medical/health measurements, or other appropriate unit of measure) against an expected measurement (in the same unit of measure). The analysis can also include efficiency assessment, cost allocation, economic evaluation, variance analysis, cost-benefit analysis, cost-effectiveness analysis, risk analysis, etc. The predicting can include predicting clinical, operational and financial outcomes for a future time based on present or past information. Alerts may be generated pertaining to any information that may need immediate attention, or for other reasons.

At 316, planning board 44 may be generated from the analysis and forecasting. At 318, dashboard 42 may be generated from the analysis and forecasting. At 320, report 46 maybe generated from the analysis and forecasting. At 322, electronic board 48 may be generated from the analysis and forecasting. Each of planning board 44, dashboard 42, report 46, and electronic board 48 may include the alerts generated at 314. Each operation 316 to 322 may be performed sequentially, upon user request, substantially simultaneously, etc., based on particular configuration settings.

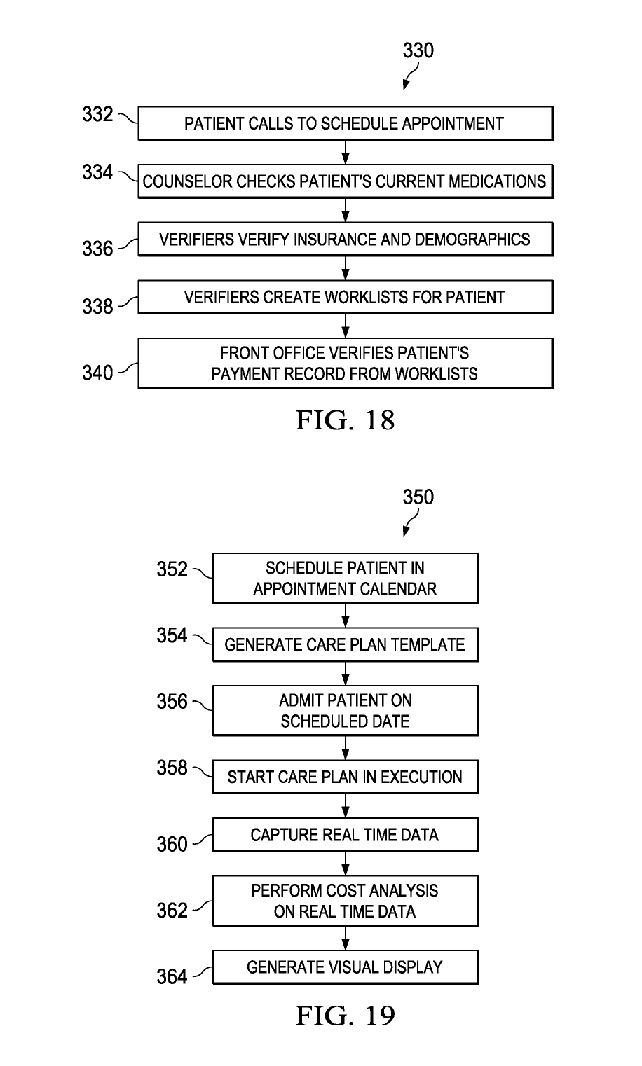

Turning to FIG. 18, FIG. 18 is a simplified flow diagram illustrating example operations 330 that may be associated with an embodiment of healthcare monitoring system 10. At 332, a patient may call a medical care facility (e.g., ASC 154) to schedule an appointment. At 334, counselor 134 may check patient's current medications. At 336, verifiers 136 may verify insurance and demographics. At 338, verifiers 136 may create worklists 142 for the patient. At 340, front office 138 may verify patient's payment records from worklists 142.

Turning to FIG. 19, FIG. 19 is a simplified flow diagram illustrating example operations 350 that may be associated with an embodiment of healthcare monitoring system 10. At 352, the patient may be scheduled in an appointment calendar. For example, the patient may schedule a surgery at ASC 154. At 354, an appropriate care plan template 192 may be generated. For example, care plan template 192 may be generated based on historical information of surgeries performed at the medical care facility; one or more directives from physicians; guidelines followed for such services; and other pertinent information. Care plan template 192 may be generated and appropriate resource item 202 and supply item 204 may be identified therefrom. In an example embodiment, cOS 31 may generate and store one or more care plan template(s) 192. When the patient schedules the appointment at the medical care facility, the patient may be associated with an appropriate care plan template 192. For example, the patient may be scheduled for cardiac surgery, and care plan template 192 may accordingly be associated with cardiac surgery. On the other hand, if the patient is scheduled for bone marrow transplant surgery, care plan template 192 may accordingly be associated with bone marrow transplant surgery.

At 356, the patient may be admitted to the medical care facility on the appointed date. At 358, care plan in execution 212 may be started. For example, relevant guidelines of the medical care facility may modify care plan template 192 to the patient. In other scenarios, the patient's individual medical history at the time of admission may alter care plan template 192 appropriately. At 360, real time data (e.g., medical data 26, operations data 27, and services data 28) may be captured. For example, each task prescribed or selected from care plan template 192 may be executed and recorded. The patient's vital signs, health condition, payments, etc. may be monitored and recorded appropriately into healthcare monitoring system 10. At any instant in time, a user with appropriate permissions may access healthcare monitoring system 10 and observe the tasks being recorded into healthcare monitoring system 10 for each patient with care plans in execution.

At 362, analysis may be performed on the real time data. The analysis can include an analysis of amount of resources, cost of resources, amount of supplies, and cost of supplies associated with the patient during execution of the care plan template. At 364, an appropriate visual display 40 may be generated. In some embodiments, the analysis may be based on user demand, and visual display 40 may be appropriately suited to the analysis performed. For example, the CMO may request dashboard 42. The analysis may include a variance analysis of the clinical pathway information. Dashboard 42 may be suitably displayed to the CMO. In another example, the ward manager may request real time data. The analysis may include a variance analysis of the clinical pathway information with further analysis on facility operations. Planning board 44 may be suitably displayed to the user based on the analysis. In yet another example, the patient may request access from the patient's room. The analysis may include an analysis of the patient's position in the clinical pathway, and appropriate education and information relevant thereto. Electronic board 48 may be suitably displayed to the patient based on the analysis. In other embodiments, the analysis may encompass substantially all preconfigured analysis of the real time data. Visual display 40 may be generated based on user demand. For example, the CMO may request dashboard 42, which may pull up the portion of the analysis results of the analysis relevant to the requested dashboard 42.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments. Furthermore, the words “optimize,” “optimization,” and related terms are terms of art that refer to improvements in speed and/or efficiency of a specified outcome and do not purport to indicate that a process for achieving the specified outcome has achieved, or is capable of achieving, an “optimal” or perfectly speedy/perfectly efficient state.

In some embodiments, the components of healthcare monitoring system 10, such as care plan template 192, activity bundle 194, activity 196, treatment type 198, task 200, resource item 202, supply item 204, care plan in execution 212, Encounter 214, encounter note 216, and Flowsheet 218 may include containers, objects, and/or data structures within a software paradigm. In some embodiments, the components may be structured in platform dependent data structures, for example, amenable to schema based database operations. In other embodiments, the components may be structured in platform independent data structures, for example, amenable to both schema based and non-schema based operations. The various components may be logically tied using schema, rules, functions, and other operations in the software framework.

In example embodiments, at least some portions of the activities outlined herein may be implemented in software in, for example, management and planning module 32. In some embodiments, one or more of these features may be implemented in hardware, provided external to these elements, or consolidated in any appropriate manner to achieve the intended functionality. The various network elements may include software (or reciprocating software) that can coordinate in order to achieve the operations as outlined herein. In still other embodiments, these elements may include any suitable algorithms, hardware, software, components, modules, interfaces, or objects that facilitate the operations thereof.

Furthermore, management and planning module 32 described and shown herein (and/or its associated structures) may also include suitable interfaces for receiving, transmitting, and/or otherwise communicating data or information in a network environment. Additionally, some of the processors and memory elements associated with the various nodes may be removed, or otherwise consolidated such that a single processor and a single memory element are responsible for certain activities. In a general sense, the arrangements depicted in the FIGURES may be more logical in their representations, whereas a physical architecture may include various permutations, combinations, and/or hybrids of these elements. It is imperative to note that countless possible design configurations can be used to achieve the operational objectives outlined here. Accordingly, the associated infrastructure has a myriad of substitute arrangements, design choices, device possibilities, hardware configurations, software implementations, equipment options, etc.

In some of example embodiments, one or more memory elements (e.g., memory element 72) can store data used for the operations described herein. This includes the memory element being able to store instructions (e.g., software, logic, code, etc.) in non-transitory media such that the instructions are executed to carry out the activities described in this Specification. The memory elements may further keep information in any suitable type of non-transitory storage medium (e.g., random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. The information being tracked, sent, received, or stored in healthcare monitoring system 10 could be provided in any database, register, table, cache, queue, control list, or storage structure, based on particular needs and implementations, all of which could be referenced in any suitable timeframe. Any of the memory items discussed herein should be construed as being encompassed within the broad term ‘memory element.’

A processor can execute any type of instructions associated with the data to achieve the operations detailed herein in this Specification. In one example, processors (e.g., processor 70) could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof. Any of the potential processing elements, modules, and machines described in this Specification should be construed as being encompassed within the broad term ‘processor.’

It is also important to note that the operations and steps described with reference to the preceding FIGURES illustrate only some of the possible scenarios that may be executed by, or within, the system. Some of these operations may be deleted or removed where appropriate, or these steps may be modified or changed considerably without departing from the scope of the discussed concepts. In addition, the timing of these operations may be altered considerably and still achieve the results taught in this disclosure. The preceding operational flows have been offered for purposes of example and discussion. Substantial flexibility is provided by the system in that any suitable arrangements, chronologies, configurations, and timing mechanisms may be provided without departing from the teachings of the discussed concepts.

Although the present disclosure has been described in detail with reference to particular arrangements and configurations, these example configurations and arrangements may be changed significantly without departing from the scope of the present disclosure. For example, although the present disclosure has been described with reference to particular communication exchanges involving certain network access and protocols, healthcare monitoring system 10 may be applicable to other exchanges or routing protocols. Moreover, although healthcare monitoring system 10 has been illustrated with reference to particular elements and operations that facilitate the communication process, these elements, and operations may be replaced by any suitable architecture or process that achieves the intended functionality of healthcare monitoring system 10.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
generating a patient care plan for each patient in a medical care facility, wherein the patient care plan comprises one or more activities, wherein each activity includes one or more tasks;
generating a patient pathway for each patient, wherein the patient pathway comprises one or more activities and one or more intermediate products;
executing the patient care plans and the patient pathways of the respective patients during encounters associated with the respective patients;
capturing real time data during the execution of the patient care plans and the patient pathways;
performing an analysis on the real time data; and
displaying the real time data in a visual display.

2. The method of claim 1, further comprising associating each patient with a care plan template, wherein the care plan template includes a framework of care for a health population with particular characteristics, condition, diagnosis, and stage in life.

3. The method of claim 1, wherein each activity is associated with one or more treatment types categorizing at least one task.

4. The method of claim 3, wherein a sequence of tasks in a specific order comprises a protocol to be followed for performing the activity during execution of the patient care plans.

5. The method of claim 1, wherein each task is categorized as belonging to one type of a group consisting of administrative, clinical, and functional types.

6. The method of claim 1, wherein each intermediate product and each task is associated with one or more resources and supplies.

7. The method of claim 6, wherein each resource is associated with a cost per unit time and each supply is associated with a cost per unit item.

8. The method of claim 1, wherein the real time data associated with each patient includes at least one data selected from a group consisting of medical data, services data, operations data, at least one clinical pathway and at least one services pathway.

9. The method of claim 1, wherein the analysis includes an analysis of amount of resources, cost of resources, amount of supplies, and cost of supplies associated with the patients during execution of the patient care plans and patient pathways.

10. The method of claim 1, further comprising consolidating a plurality of care plan templates into a flowsheet, with duplicate items removed.

11. One or more non-transitory tangible media encoding instructions for execution, which when executed by a processor, is operable to perform operations comprising:
generating a patient care plan for each patient in a medical care facility, wherein the patient care plan comprises one or more activities, wherein each activity includes one or more tasks;
generating a patient pathway for each patient, wherein the patient pathway comprises one or more activities and one or more intermediate products;
executing the patient care plans and the patient pathways of the respective patients during encounters associated with the respective patients;
capturing real time data during the execution of the patient care plans and the patient pathways;
performing an analysis on the real time data; and
displaying the real time data in a visual display.

12. The media of claim 11, comprising associating each patient with a care plan template, wherein the care plan template includes a framework of care for a health population with particular characteristics, condition, diagnosis, and stage in life.

13. The media of claim 11, wherein the real time data includes at least one data selected from a group consisting of medical data, services data, operations data, at least one clinical pathway, and at least one services pathway.

14. The media of claim 11, wherein each resource is associated with a cost per unit time and each supply is associated with a cost per unit item.

15. The media of claim 11, wherein the analysis includes an analysis of amount of resources, cost of resources, amount of supplies, and cost of supplies associated with the patient during execution of the care plan template.

16. An apparatus, comprising:
a memory element to store data; and
a processor to execute instructions associated with the data, wherein the processor and the memory element cooperate such that the apparatus is configured for:
generating a patient care plan for each patient in a medical care facility, wherein the patient care plan comprises one or more activities, wherein each activity includes one or more tasks;
generating a patient pathway for each patient, wherein the patient pathway comprises one or more activities and one or more intermediate products;
executing the patient care plans and the patient pathways of the respective patients during encounters associated with the respective patients;
capturing real time data during the execution of the patient care plans and the patient pathways;
performing an analysis on the real time data; and
displaying the real time data in a visual display.

17. The apparatus of claim 16, comprising associating each patient with a care plan template, wherein the care plan template includes a framework of care for a health population with particular characteristics, condition, diagnosis, and stage in life.

18. The apparatus of claim 16, wherein the real time data includes at least one data selected from a group consisting of medical data, services data, operations data, at least one clinical pathway, and at least one services pathway.

19. The apparatus of claim 16, wherein each resource is associated with a cost per unit time and each supply is associated with a cost per unit item.

20. The apparatus of claim 16, wherein the analysis includes an analysis of amount of resources, cost of resources, amount of supplies, and cost of supplies associated with the patient during execution of the care plan template.
